(19) United States
(12) Patent Application Publication
(10) Pub. No.: US 2015/0175748 A1
(43) Pub. Date: Jun. 25, 2015

(54) Process for Production of Poly(Arylene Sulfide)

(71) Applicant: Chevron Phillips Chemical Company LP, The Woodlands, TX (US)

(72) Inventors: Jeffrey S. Fodor, Bartlesville, OK (US); R. Shawn Childress, Bartlesville, OK (US); Kent E. Mitchell, Bartlesville, OK (US); Kendall M. Hurst, Collinsville, OK (US)

(73) Assignee: Chevron Phillips Chemical Company LP, The Woodlands, TX (US)

(21) Appl. No.: 14/135,219

(22) Filed: Dec. 19, 2013

(51) Int. Cl. C08G 75/14

(52) U.S. Cl. CPC C08G 75/14

(57) ABSTRACT

A process for producing a poly(arylene sulfide) polymer comprising (a) polymerizing reactants in a reaction vessel to produce a poly(arylene sulfide) reaction mixture, (b) processing the poly(arylene sulfide) reaction mixture to obtain a poly(arylene sulfide) polymer and a by-product slurry, (c) removing (e.g., evaporating) at least a portion of the by-product slurry to yield salt solids particulates, wherein at least a portion of the evaporating is carried out while simultaneously sizing the salt solids particulates to a desired size.

### TECHNICAL FIELD

The present disclosure relates to a method of making polymers. More specifically, the present disclosure relates to a process for the production of polymers, such as for example poly(arylene sulfide) polymers.

### BACKGROUND

Polymers, such as poly(arylene sulfide) polymers and their derivatives, are used for the production of a wide variety of articles. Generally, the process for producing a particular polymer and any steps thereof can drive the cost of such particular polymer, and consequently influences the economics of polymer articles. Thus, there is an ongoing need to develop and/or improve processes for producing these polymers.

### BRIEF SUMMARY

Disclosed herein is a process for producing a poly(arylene sulfide) polymer comprising (a) polymerizing reactants in a reaction vessel to produce a poly(arylene sulfide) reaction mixture, (b) processing the poly(arylene sulfide) reaction mixture to obtain a poly(arylene sulfide) polymer and a by-product slurry, (c) removing (e.g., evaporating) at least a portion of the by-product slurry to yield salt solids particulates, wherein at least a portion of the evaporating is carried out while simultaneously sizing the salt solids particulates to a desired size.

Also disclosed herein is a process for producing a poly(phenylene sulfide) polymer comprising (a) polymerizing reactants in a reaction vessel to produce a poly(phenylene sulfide) reaction mixture, (b) processing the poly(phenylene sulfide) reaction mixture to obtain a poly(phenylene sulfide) polymer and a by-product slurry, and (c) removing (e.g., evaporating) at least a portion of the by-product slurry to yield salt solids particulates, wherein at least a portion of the evaporating is carried out while simultaneously sizing the salt solids particulates to a desired size.

Further disclosed herein is a process for producing a poly(phenylene sulfide) polymer comprising (a) reacting a sulfur source and a dihaloaromatic compound in the presence of N-methyl-2-pyrrolidone to form a poly(phenylene sulfide) reaction mixture, (b) washing the poly(phenylene sulfide) reaction mixture with N-methyl-2-pyrrolidone and/or water to obtain a washed poly(phenylene sulfide) polymer and by-product slurry, and (c) removing (e.g., evaporating) at least a portion of the by-product slurry to yield salt solids particulates, wherein at least a portion of the evaporating is carried out while simultaneously sizing the salt solids particulates to a desired size.

Further disclosed herein is a process for producing a poly(arylene sulfide) polymer comprising (i) polymerizing reactants in a reaction vessel to produce a poly(arylene sulfide) reaction mixture, (ii) washing the poly(arylene sulfide) reaction mixture with a polar organic compound and/or water to obtain a raw poly(arylene sulfide) polymer and a first slurry, (iii) treating at least a portion of the raw poly(arylene sulfide) polymer with an aqueous acid solution and/or an aqueous metal cation solution to obtain a treated poly(arylene sulfide) polymer, (iv) drying at least a portion of the raw poly(arylene sulfide) polymer and/or treated poly(arylene sulfide) polymer to obtain a dried poly(arylene sulfide) polymer, (v) removing (e.g., evaporating) a portion of the first slurry to obtain a by-product slurry, wherein the by-product slurry comprises slurry particulates, and (vi) removing (e.g., evaporating) at least a portion of the polar organic compound and/or water from the by-product slurry to yield salt solids particulates, wherein at least a portion of the evaporating is carried out while simultaneously sizing the salt solids particulates to a desired size.

Further disclosed herein is a process for producing a poly(phenylene sulfide) polymer comprising (i) reacting a sulfur source and a dihaloaromatic compound in the presence of N-methyl-2-pyrrolidone to form a poly(phenylene sulfide) reaction mixture, (ii) washing the poly(phenylene sulfide) reaction mixture with N-methyl-2-pyrrolidone and/or water to obtain a raw poly(phenylene sulfide) polymer and a first slurry, (iii) treating at least a portion of the raw poly(phenylene sulfide) polymer with an aqueous acid solution and/or an aqueous metal cation solution to obtain a treated poly(phenylene sulfide) polymer, (iv) drying at least a portion of the raw poly(phenylene sulfide) polymer and/or treated poly(phenylene sulfide) polymer to obtain a dried poly(phenylene sulfide) polymer, (v) removing (e.g., evaporating) a portion of the first slurry to obtain a by-product slurry, wherein the by-product slurry comprises slurry particulates, and (vi) removing (e.g., evaporating) at least a portion of the N-methyl-2-pyrrolidone and/or water from the by-product slurry to yield salt solids particulates, wherein at least a portion of the evaporating is carried out while simultaneously sizing the salt solids particulates to a desired size.

Further disclosed herein is a process for recovering N-methyl-2-pyrrolidone during production of poly(phenylene sulfide) polymer, comprising (i) reacting a sulfur source and a dihaloaromatic compound in the presence of N-methyl-2-pyrrolidone to form a poly(phenylene sulfide) reaction mixture, (ii) washing the poly(phenylene sulfide) reaction mixture with N-methyl-2-pyrrolidone and/or water to obtain a raw poly(phenylene sulfide) polymer and a first slurry, (iii) treating at least a portion of the raw poly(phenylene sulfide) polymer with an aqueous acid solution and/or an aqueous metal cation solution to obtain a treated poly(phenylene sulfide) polymer, (iv) drying at least a portion of the raw poly(phenylene sulfide) polymer and/or treated poly(phenylene sulfide) polymer to obtain a dried poly(phenylene sulfide) polymer, (v) removing (e.g., evaporating) a portion of the first slurry to obtain a by-product slurry and a vapor stream, wherein the by-product slurry comprises slurry particulates, and (vi) removing (e.g., evaporating) at least a portion of the N-methyl-2-pyrrolidone and/or water from the by-product slurry to yield salt solids particulates and recovered N-methyl-2-pyrrolidone, wherein at least a portion of the evaporating is carried out while simultaneously sizing the salt solids particulates to a desired size, wherein the salt solids particulates comprise equal to or less than 5 weight percent N-methyl-2-pyrrolidone, and wherein at least a portion of the recovered N-methyl-2-pyrrolidone is re-used in step (i), step (ii), or both.

Further disclosed herein is a system for producing a poly(phenylene sulfide) polymer comprising (a) a reactor, wherein a sulfur source and a dihaloaromatic compound are reacted in the presence of N-methyl-2-pyrrolidone to form a poly(phenylene sulfide) reaction mixture, (b) a washing vessel receiving the poly(phenylene sulfide) reaction mixture, wherein the poly(phenylene sulfide) reaction mixture is washed with N-methyl-2-pyrrolidone and/or water to obtain a washed poly(phenylene sulfide) polymer and by-product slurry, and (c) a sizing dryer receiving the by-product slurry, wherein at least a portion of the by-product slurry is removed (e.g., evaporated) to yield salt solids particulates, wherein at least a portion of the removing (e.g., evaporating) is carried out while simultaneously sizing the salt solids particulates to a desired size, and wherein the salt solids particulates comprise equal to or less than about 5 weight percent N-methyl-2-pyrrolidone.

### DETAILED DESCRIPTION

Disclosed herein are methods of making poly(arylene sulfide) polymers. The present application relates to a poly(arylene sulfide) polymers, also referred to herein simply as “poly(arylene sulfide).” In the various embodiments disclosed herein, it is to be expressly understood that reference to poly(arylene sulfide) polymer specifically includes, without limitation, polyphenylene sulfide polymer (or simply, polyphenylene sulfide), also referred to as PPS polymer (or simply, PPS). In an embodiment, a process for the production of a poly(arylene sulfide) polymer can comprise the steps of (a) polymerizing reactants in a reaction vessel to produce a poly(arylene sulfide) reaction mixture; (b) processing the poly(arylene sulfide) reaction mixture to obtain a poly(arylene sulfide) polymer and a by-product slurry; and (c) evaporating at least a portion of the by-product slurry to yield salt solids particulates, wherein at least a portion of the evaporating is carried out while simultaneously sizing the salt solids particulates to a desired size. In an embodiment, step (c) evaporating can yield a recovered polar organic compound, wherein at least a portion of the recovered polar organic compound can be recycled/reused in a subsequent polymerization process for producing a poly(arylene sulfide) polymer. In an embodiment, at least a portion of the recovered polar organic compound can be recycled/reused in step (a) polymerizing reactants and/or step (b) processing the poly(arylene sulfide) reaction mixture.

In an embodiment, a process for the production of a poly(arylene sulfide) polymer can comprise the steps of (i) polymerizing reactants in a reaction vessel to produce a poly(arylene sulfide) reaction mixture; (ii) washing the poly(arylene sulfide) reaction mixture with a polar organic compound and/or water to obtain a raw poly(arylene sulfide) polymer and a first slurry; (iii) treating at least a portion of the raw poly(arylene sulfide) polymer with an aqueous acid solution and/or an aqueous metal cation solution to obtain a treated poly(arylene sulfide) polymer; (iv) drying at least a portion of the raw poly(arylene sulfide) polymer and/or treated poly(arylene sulfide) polymer to obtain a dried poly(arylene sulfide) polymer; (v) evaporating a portion of the first slurry to obtain a by-product slurry, wherein the by-product slurry comprises slurry particulates; and (vi) evaporating or removing at least a portion of the polar organic compound and/or water from the by-product slurry to yield salt solids particulates, wherein at least a portion of the evaporating is carried out while simultaneously sizing the salt solids particulates to a desired size. In an embodiment, steps (v) evaporating a portion of the first slurry and/or (vi) evaporating at least a portion of the polar organic compound and/or water can yield a recovered polar organic compound, wherein at least a portion of the recovered polar organic compound can be recycled/reused in a subsequent polymerization process for producing a poly(arylene sulfide) polymer. In an embodiment, at least a portion of the recovered polar organic compound can be recycled/reused in step (i) polymerizing reactants and/or step (ii) washing the poly(arylene sulfide) reaction mixture.

In an embodiment, the process for the production of a poly(arylene sulfide) polymer disclosed herein can exhibit improvements in one or more process characteristics when compared to an otherwise similar process lacking a step of evaporating at least a portion of the by-product slurry to yield salt solids particulates, wherein at least a portion of the evaporating is carried out while simultaneously sizing the salt solids particulates to a desired size. For example, the process for the production of a poly(arylene sulfide) polymer disclosed herein can be characterized by an improved process downtime (e.g., a shorter process downtime) when compared to an otherwise similar process lacking a step of evaporating at least a portion of the by-product slurry to yield salt solids particulates, wherein at least a portion of the evaporating is carried out while simultaneously sizing the salt solids particulates to a desired size. While the present disclosure will be discussed in detail in the context of a process for the production of a poly(arylene sulfide) polymer, it should be understood that such process or any steps thereof can be applied in a process for the production of any other suitable polymer. The polymer can comprise any polymer compatible with the disclosed processes and materials.

To define more clearly the terms used herein, the following definitions are provided. Unless otherwise indicated, the following definitions are applicable to this disclosure. If a term is used in this disclosure but is not specifically defined herein, the definition from the IUPAC Compendium of Chemical Terminology, 2nd Ed (1997) can be applied, as long as that definition does not conflict with any other disclosure or definition applied herein, or render indefinite or non-enabled any claim to which that definition is applied. To the extent that any definition or usage provided by any document incorporated herein by reference conflicts with the definition or usage provided herein, the definition or usage provided herein controls.

Groups of elements of the table are indicated using the numbering scheme indicated in the version of the periodic table of elements published in Chemical and Engineering News, 63(5), 27, 1985. In some instances a group of elements can be indicated using a common name assigned to the group; for example alkali earth metals (or alkali metals) for Group 1 elements, alkaline earth metals (or alkaline metals) for Group 2 elements, transition metals for Group 3-12 elements, and halogens for Group 17 elements.

A chemical “group” is described according to how that group is formally derived from a reference or “parent” compound, for example, by the number of hydrogen atoms formally removed from the parent compound to generate the group, even if that group is not literally synthesized in this manner. These groups can be utilized as substituents or coordinated or bonded to metal atoms. By way of example, an “alkyl group” formally can be derived by removing one hydrogen atom from an alkane, while an “alkylene group” formally can be derived by removing two hydrogen atoms from an alkane. Moreover, a more general term can be used to encompass a variety of groups that formally are derived by removing any number (“one or more”) hydrogen atoms from a parent compound, which in this example can be described as an “alkane group,” and which encompasses an “alkyl group,” an “alkylene group,” and materials have three or more hydrogen atoms, as necessary for the situation, removed from the alkane. Throughout, the disclosure that a substituent, ligand, or other chemical moiety can constitute a particular “group” implies that the well-known rules of chemical structure and bonding are followed when that group is employed as described. When describing a group as being “derived by,” “derived from,” “formed by,” or “formed from,” such terms are used in a formal sense and are not intended to reflect any specific synthetic methods or procedure, unless specified otherwise or the context requires otherwise.

The term “substituted” when used to describe a group, for example, when referring to a substituted analog of a particular group, is intended to describe any non-hydrogen moiety that formally replaces a hydrogen in that group, and is intended to be non-limiting. A group or groups can also be referred to herein as “unsubstituted” or by equivalent terms such as “non-substituted,” which refers to the original group in which a non-hydrogen moiety does not replace a hydrogen within that group. “Substituted” is intended to be non-limiting and include inorganic substituents or organic substituents.

Unless otherwise specified, any carbon-containing group for which the number of carbon atoms is not specified can have, according to proper chemical practice, 1, 2, 3, 4, 5, 6, 7, 8, 9, 10, 11, 12, 13, 14, 15, 16, 17, 18, 19, 20, 21, 22, 23, 24, 25, 26, 27, 28, 29, or 30 carbon atoms, or any range or combination of ranges between these values. For example, unless otherwise specified, any carbon-containing group can have from 1 to 30 carbon atoms, from 1 to 25 carbon atoms, from 1 to 20 carbon atoms, from 1 to 15 carbon atoms, from 1 to 10 carbon atoms, or from 1 to 5 carbon atoms, and the like. Moreover, other identifiers or qualifying terms can be utilized to indicate the presence or absence of a particular substituent, a particular regiochemistry and/or stereochemistry, or the presence or absence of a branched underlying structure or backbone.

Within this disclosure the normal rules of organic nomenclature will prevail. For instance, when referencing substituted compounds or groups, references to substitution patterns are taken to indicate that the indicated group(s) is (are) located at the indicated position and that all other non-indicated positions are hydrogen. For example, reference to a 4-substituted phenyl group indicates that there is a non-hydrogen substituent located at the 4 position and hydrogens located at the 2, 3, 5, and 6 positions. By way of another example, reference to a 3-substituted naphth-2-yl indicates that there is a non-hydrogen substituent located at the 3 position and hydrogens located at the 1, 4, 5, 6, 7, and 8 positions. References to compounds or groups having substitutions at positions in addition to the indicated position will be referenced using comprising or some other alternative language. For example, a reference to a phenyl group comprising a substituent at the 4 position refers to a group having a non-hydrogen atom at the 4 position and hydrogen or any non-hydrogen group at the 2, 3, 5, and 6 positions.

The term “organyl group” is used herein in accordance with the definition specified by IUPAC: an organic substituent group, regardless of functional type, having one free valence at a carbon atom. Similarly, an “organylene group” refers to an organic group, regardless of functional type, derived by removing two hydrogen atoms from an organic compound, either two hydrogen atoms from one carbon atom or one hydrogen atom from each of two different carbon atoms. An “organic group” refers to a generalized group formed by removing one or more hydrogen atoms from carbon atoms of an organic compound. Thus, an “organyl group,” an “organylene group,” and an “organic group” can contain organic functional group(s) and/or atom(s) other than carbon and hydrogen, that is, an organic group that can comprise functional groups and/or atoms in addition to carbon and hydrogen. For instance, non-limiting examples of atoms other than carbon and hydrogen include halogens, oxygen, nitrogen, phosphorus, and the like. Non-limiting examples of functional groups include ethers, aldehydes, ketones, esters, sulfides, amines, and phosphines, and so forth. In one aspect, the hydrogen atom(s) removed to form the “organyl group,” “organylene group,” or “organic group” can be attached to a carbon atom belonging to a functional group, for example, an acyl group (—C(O)R), a formyl group (—C(O)H), a carboxy group (—C(O)OH), a hydrocarboxycarbonyl group (—C(O)OR), a cyano group (—C≡N), a carbamoyl group (—C(O)NH₂), a N-hydrocarbylcarbamoyl group (—C(O)NHR), or N,N′-dihydrocarbylcarbamoyl group (—C(O)NR₂), among other possibilities. In another aspect, the hydrogen atom(s) removed to form the “organyl group,” “organylene group,” or “organic group” can be attached to a carbon atom not belonging to, and remote from, a functional group, for example, —CH₂C(O)CH₃, —CH₂NR₂. An “organyl group,” “organylene group,” or “organic group” can be aliphatic, inclusive of being cyclic or acyclic, or can be aromatic. “Organyl groups,” “organylene groups,” and “organic groups” also encompass heteroatom-containing rings, heteroatom-containing ring systems, heteroaromatic rings, and heteroaromatic ring systems. “Organyl groups,” “organylene groups,” and “organic groups” can be linear or branched unless otherwise specified. Finally, it is noted that the “organyl group,” “organylene group,” or “organic group” definitions include “hydrocarbyl group,” “hydrocarbylene group,” “hydrocarbon group,” respectively, and “alkyl group,” “alkylene group,” and “alkane group,” respectively, as members.

The term “hydrocarbon” whenever used in this specification and claims refers to a compound containing only carbon and hydrogen. Other identifiers can be utilized to indicate the presence of particular groups in the hydrocarbon (e.g. halogenated hydrocarbon indicates the presence of one or more halogen atoms replacing an equivalent number of hydrogen atoms in the hydrocarbon). The term “hydrocarbyl group” is used herein in accordance with the definition specified by IUPAC: a univalent group formed by removing a hydrogen atom from a hydrocarbon (that is, a group containing only carbon and hydrogen). Similarly, a “hydrocarbylene group” refers to a group formed by removing two hydrogen atoms from a hydrocarbon, either two hydrogen atoms from one carbon atom or one hydrogen atom from each of two different carbon atoms. Therefore, in accordance with the terminology used herein, a “hydrocarbon group” refers to a generalized group formed by removing one or more hydrogen atoms (as necessary for the particular group) from a hydrocarbon. A “hydrocarbyl group,” “hydrocarbylene group,” and “hydrocarbon group” can be acyclic or cyclic groups, and/or can be linear or branched. A “hydrocarbyl group,” “hydrocarbylene group,” and “hydrocarbon group” can include rings, ring systems, aromatic rings, and aromatic ring systems, which contain only carbon and hydrogen. “Hydrocarbyl groups,” “hydrocarbylene groups,” and “hydrocarbon groups” include, by way of example, aryl, arylene, arene groups, alkyl, alkylene, alkane group, cycloalkyl, cycloalkylene, cycloalkane groups, aralkyl, aralkylene, and aralkane groups, respectively, among other groups as members.

The term “alkane” whenever used in this specification and claims refers to a saturated hydrocarbon compound. Other identifiers can be utilized to indicate the presence of particular groups in the alkane (e.g. halogenated alkane indicates the presence of one or more halogen atoms replacing an equivalent number of hydrogen atoms in the alkane). The term “alkyl group” is used herein in accordance with the definition specified by IUPAC: a univalent group formed by removing a hydrogen atom from an alkane. Similarly, an “alkylene group” refers to a group formed by removing two hydrogen atoms from an alkane (either two hydrogen atoms from one carbon atom or one hydrogen atom from two different carbon atoms). An “alkane group” is a general term that refers to a group formed by removing one or more hydrogen atoms (as necessary for the particular group) from an alkane. An “alkyl group,” “alkylene group,” and “alkane group” can be acyclic or cyclic groups, and/or can be linear or branched unless otherwise specified.

A “cycloalkane” is a saturated cyclic hydrocarbon, with or without side chains, for example, cyclobutane. Other identifiers can be utilized to indicate the presence of particular groups in the cycloalkane (e.g. halogenated cycloalkane indicates the presence of one or more halogen atoms replacing an equivalent number of hydrogen atoms in the cycloalkane). Unsaturated cyclic hydrocarbons having one or more endocyclic double or triple bonds are called cycloalkenes and cycloalkynes, respectively. Cycloalkenes and cycloalkynes having only one, only two, and only three endocyclic double or triple bonds, respectively, can be identified by use of the term “mono,” “di,” and “tri within the name of the cycloalkene or cycloalkyne. Cycloalkenes and cycloalkynes can further identify the position of the endocyclic double or triple bonds. Other identifiers can be utilized to indicate the presence of particular groups in the cycloalkane (e.g. halogenated cycloalkane indicates that the presence of one or more halogen atoms replacing an equivalent number of hydrogen atoms in the cycloalkane).

A “cycloalkyl group” is a univalent group derived by removing a hydrogen atom from a ring carbon atom from a cycloalkane. For example, a 1-methylcyclopropyl group and a 2-methylcyclopropyl group are illustrated as follows.

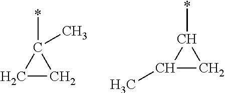

Similarly, a “cycloalkylene group” refers to a group derived by removing two hydrogen atoms from a cycloalkane, at least one of which is a ring carbon. Thus, a “cycloalkylene group” includes both a group derived from a cycloalkane in which two hydrogen atoms are formally removed from the same ring carbon, a group derived from a cycloalkane in which two hydrogen atoms are formally removed from two different ring carbons, and a group derived from a cycloalkane in which a first hydrogen atom is formally removed from a ring carbon and a second hydrogen atom is formally removed from a carbon atom that is not a ring carbon. A “cycloalkane group” refers to a generalized group formed by removing one or more hydrogen atoms (as necessary for the particular group and at least one of which is a ring carbon) from a cycloalkane. It should be noted that according to the definitions provided herein, general cycloalkane groups (including cycloalkyl groups and cycloalkylene groups) include those having zero, one, or more than one hydrocarbyl substituent groups attached to a cycloalkane ring carbon atom (e.g. a methylcyclopropyl group) and is member of the group of hydrocarbon groups. However, when referring to a cycloalkane group having a specified number of cycloalkane ring carbon atoms (e.g. cyclopentane group or cyclohexane group, among others), the base name of the cycloalkane group having a defined number of cycloalkane ring carbon atoms refers to the unsubstituted cycloalkane group. Consequently, a substituted cycloalkane group having a specified number of ring carbon atoms (e.g. substituted cyclopentane or substituted cyclohexane, among others) refers to the respective group having one or more substituent groups (including halogens, hydrocarbyl groups, or hydrocarboxy groups, among other substituent groups) attached to a cycloalkane group ring carbon atom. When the substituted cycloalkane group having a defined number of cycloalkane ring carbon atoms is a member of the group of hydrocarbon groups (or a member of the general group of cycloalkane groups), each substituent of the substituted cycloalkane group having a defined number of cycloalkane ring carbon atoms is limited to hydrocarbyl substituent group. One can readily discern and select general groups, specific groups, and/or individual substituted cycloalkane group(s) having a specific number of ring carbons atoms which can be utilized as member of the hydrocarbon group (or a member of the general group of cycloalkane groups).

An aromatic compound is a compound containing a cyclically conjugated double bond system that follows the Hückel (4n+2) rule and contains (4n+2) pi-electrons, where n is an integer from 1 to 5. Aromatic compounds include “arenes” (hydrocarbon aromatic compounds) and “heteroarenes,” also termed “hetarenes” (heteroaromatic compounds formally derived from arenes by replacement of one or more methine (—C═) carbon atoms of the cyclically conjugated double bond system with a trivalent or divalent heteroatoms, in such a way as to maintain the continuous pi-electron system characteristic of an aromatic system and a number of out-of-plane pi-electrons corresponding to the Hückel rule (4n+2). While arene compounds and heteroarene compounds are mutually exclusive members of the group of aromatic compounds, a compound that has both an arene group and a heteroarene group are generally considered a heteroarene compound. Aromatic compounds, arenes, and heteroarenes can be monocyclic (e.g., benzene, toluene, furan, pyridine, methylpyridine) or polycyclic unless otherwise specified. Polycyclic aromatic compounds, arenes, and heteroarenes, include, unless otherwise specified, compounds wherein the aromatic rings can be fused (e.g., naphthalene, benzofuran, and indole), compounds where the aromatic groups can be separate and joined by a bond (e.g., biphenyl or 4-phenylpyridine), or compounds where the aromatic groups are joined by a group containing linking atoms (e.g., carbon—the methylene group in diphenylmethane; oxygen—diphenyl ether; nitrogen—triphenyl amine; among others linking groups). As disclosed herein, the term “substituted” can be used to describe an aromatic group, arene, or heteroarene wherein a non-hydrogen moiety formally replaces a hydrogen in the compound, and is intended to be non-limiting.

An “aromatic group” refers to a generalized group formed by removing one or more hydrogen atoms (as necessary for the particular group and at least one of which is an aromatic ring carbon atom) from an aromatic compound. For a univalent “aromatic group,” the removed hydrogen atom must be from an aromatic ring carbon. For an “aromatic group” formed by removing more than one hydrogen atom from an aromatic compound, at least one hydrogen atom must be from an aromatic hydrocarbon ring carbon. Additionally, an “aromatic group” can have hydrogen atoms removed from the same ring of an aromatic ring or ring system (e.g., phen-1,4-ylene, pyridin-2,3-ylene, naphth-1,2-ylene, and benzofuran-2,3-ylene), hydrogen atoms removed from two different rings of a ring system (e.g., naphth-1,8-ylene and benzofuran-2,7-ylene), or hydrogen atoms removed from two isolated aromatic rings or ring systems (e.g., bis(phen-4-ylene)methane).

An arene is aromatic hydrocarbon, with or without side chains (e.g. benzene, toluene, or xylene, among others). An “aryl group” is a group derived by the formal removal of a hydrogen atom from an aromatic ring carbon of an arene. It should be noted that the arene can contain a single aromatic hydrocarbon ring (e.g., benzene, or toluene), contain fused aromatic rings (e.g., naphthalene or anthracene), and/or contain one or more isolated aromatic rings covalently linked via a bond (e.g., biphenyl) or non-aromatic hydrocarbon group(s) (e.g., diphenylmethane). One example of an “aryl group” is ortho-tolyl (o-tolyl), the structure of which is shown here.

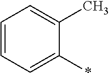 [SMILES: *c1ccccc1C]

Similarly, an “arylene group” refers to a group formed by removing two hydrogen atoms (at least one of which is from an aromatic ring carbon) from an arene. An “arene group” refers to a generalized group formed by removing one or more hydrogen atoms (as necessary for the particular group and at least one of which is an aromatic ring carbon) from an arene. However, if a group contains separate and distinct arene and heteroarene rings or ring systems (e.g., the phenyl and benzofuran moieties in 7-phenylbenzofuran) its classification depends upon the particular ring or ring system from which the hydrogen atom was removed, that is, a substituted arene group if the removed hydrogen came from the aromatic hydrocarbon ring or ring system carbon atom (e.g., the 2 carbon atom in the phenyl group of 6-phenylbenzofuran) and a heteroarene group if the removed hydrogen carbon came from a heteroaromatic ring or ring system carbon atom (e.g., the 2 or 7 carbon atom of the benzofuran group of 6-phenylbenzofuran). It should be noted that according the definitions provided herein, general arene groups (including an aryl group and an arylene group) include those having zero, one, or more than one hydrocarbyl substituent groups located on an aromatic hydrocarbon ring or ring system carbon atom (e.g., a toluene group or a xylene group, among others) and is a member of the group of hydrocarbon groups. However, a phenyl group (or phenylene group) and/or a naphthyl group (or naphthylene group) refer to the specific unsubstituted arene groups. Consequently, a substituted phenyl group or substituted naphthyl group refers to the respective arene group having one or more substituent groups (including halogens, hydrocarbyl groups, or hydrocarboxy groups, among others) located on an aromatic hydrocarbon ring or ring system carbon atom. When the substituted phenyl group and/or substituted naphthyl group is a member of the group of hydrocarbon groups (or a member of the general group of arene groups), each substituent is limited to a hydrocarbyl substituent group. One having ordinary skill in the art can readily discern and select general phenyl and/or naphthyl groups, specific phenyl and/or naphthyl groups, and/or individual substituted phenyl or substituted naphthyl groups which can be utilized as a member of the group of hydrocarbon groups (or a member of the general group of arene groups).

Regarding claim transitional terms or phrases, the transitional term “comprising”, which is synonymous with “including,” “containing,” “having,” or “characterized by,” is inclusive or open-ended and does not exclude additional, unrecited elements or method steps. The transitional phrase “consisting of” excludes any element, step, or ingredient not specified in the claim. The transitional phrase “consisting essentially of” limits the scope of a claim to the specified materials or steps and those that do not materially affect the basic and novel characteristic(s) of the claimed invention. The term “consisting essentially of” occupies a middle ground between closed terms like “consisting of” and fully open terms like “comprising.” Absent an indication to the contrary, when describing a compound or composition “consisting essentially of” is not to be construed as “comprising,” but is intended to describe the recited component that includes materials which do not significantly alter composition or method to which the term is applied. For example, a feedstock consisting essentially of a material A can include impurities typically present in a commercially produced or commercially available sample of the recited compound or composition. When a claim includes different features and/or feature classes (for example, a method step, feedstock features, and/or product features, among other possibilities), the transitional terms comprising, consisting essentially of, and consisting of apply only to feature class to which is utilized and it is possible to have different transitional terms or phrases utilized with different features within a claim. For example a method can comprise several recited steps (and other non-recited steps) but utilize a catalyst system preparation consisting of specific or alternatively consisting essentially of specific steps but utilize a catalyst system comprising recited components and other non-recited components.

While compositions and methods are described in terms of “comprising” (or other broad term) various components and/or steps, the compositions and methods can also be described using narrower terms such as “consist essentially of” or “consist of” the various components and/or steps.

Use of the term “optionally” with respect to any element of a claim is intended to mean that the subject element is required, or alternatively, is not required. Both alternatives are intended to be within the scope of the claim.

The terms “a,” “an,” and “the” are intended, unless specifically indicated otherwise, to include plural alternatives, e.g., at least one. For any particular compound or group disclosed herein, any name or structure presented is intended to encompass all conformational isomers, regioisomers, and stereoisomers that can arise from a particular set of substituents, unless otherwise specified. For example, a general reference to pentane includes n-pentane, 2-methyl-butane, and 2,2-dimethylpropane and a general reference to a butyl group includes an n-butyl group, a sec-butyl group, an iso-butyl group, and t-butyl group. The name or structure also encompasses all enantiomers, diastereomers, and other optical isomers whether in enantiomeric or racemic forms, as well as mixtures of stereoisomers, as would be recognized by a skilled artisan, unless otherwise specified.

The terms “room temperature” or “ambient temperature” are used herein to describe any temperature from 15° C. to 35° C. wherein no external heat or cooling source is directly applied to the reaction vessel. Accordingly, the terms “room temperature” and “ambient temperature” encompass the individual temperatures and any and all ranges, subranges, and combinations of subranges of temperatures from 15° C. to 35° C. wherein no external heating or cooling source is directly applied to the reaction vessel. The term “atmospheric pressure” is used herein to describe an earth air pressure wherein no external pressure modifying means is utilized. Generally, unless practiced at extreme earth altitudes, “atmospheric pressure” is about 1 atmosphere (alternatively, about 14.7 psi or about 101 kPa).

Features within this disclosure that are provided as a minimum values can be alternatively stated as “at least” or “greater than or equal to” any recited minimum value for the feature disclosed herein. Features within this disclosure that are provided as a maximum values can be alternatively stated as “less than or equal to” any recited maximum value for the feature disclosed herein.

Embodiments disclosed herein can provide the materials listed as suitable for satisfying a particular feature of the embodiment delimited by the term “or.” For example, a particular feature of the disclosed subject matter can be disclosed as follows: Feature X can be A, B, or C. It is also contemplated that for each feature the statement can also be phrased as a listing of alternatives such that the statement “Feature X is A, alternatively B, or alternatively C” is also an embodiment of the present disclosure whether or not the statement is explicitly recited.

In an embodiment, the process for the production of a poly(arylene sulfide) polymer can comprise a step of polymerizing reactants in a reaction vessel or reactor to produce a poly(arylene sulfide) reaction mixture.

In an embodiment, the polymers disclosed herein are poly(arylene sulfide) polymers. In an embodiment, the polymer can comprise a poly(arylene sulfide). In other embodiments, the polymer can comprise a poly(phenylene sulfide). Herein, the polymer refers both to a material collected as the product of a polymerization reaction (e.g., a reactor or virgin resin) and a polymeric composition comprising a polymer and one or more additives. In an embodiment, a monomer (e.g., p-dichlorobenzene) can be polymerized using the methodologies disclosed herein to produce a polymer of the type disclosed herein. In an embodiment, the polymer can comprise a homopolymer or a copolymer. It is to be understood that an inconsequential amount of comonomer can be present in the polymers disclosed herein and the polymer still be considered a homopolymer. Herein an inconsequential amount of a comonomer refers to an amount that does not substantively affect the properties of the polymer disclosed herein. For example a comonomer can be present in an amount of less than about 1.0 wt. %, 0.5 wt. %, 0.1 wt. %, or 0.01 wt. %, based on the total weight of polymer.

Generally, poly(arylene sulfide) is a polymer comprising a —(Ar—S)— repeating unit, wherein Ar is an arylene group. Unless otherwise specified the arylene groups of the poly(arylene sulfide) can be substituted or unsubstituted; alternatively, substituted; or alternatively, unsubstituted. Additionally, unless otherwise specified, the poly(arylene sulfide) can include any isomeric relationship of the sulfide linkages in polymer; e.g., when the arylene group is a phenylene group the sulfide linkages can be ortho, meta, para, or combinations thereof.

In an aspect, poly(arylene sulfide) can contain at least 5, 10, 20, 30, 40, 50, 60, 70 mole percent of the —(Ar—S)— unit. In an embodiment, the poly(arylene sulfide) can contain up to 50, 70, 80, 90, 95, 99, or 100 mole percent of the —(Ar—S)— unit. In some embodiments, poly(arylene sulfide) can contain from any minimum mole percent of the —(Ar—S)— unit disclosed herein to any maximum mole percent of the —(Ar—S)— unit disclosed herein; for example, from 5 to 99 mole percent, 30 to 70 mole percent, or 70 to 95 mole percent of the —(Ar—S)— unit. Other ranges for the poly(arylene sulfide) units are readily apparent from the present disclosure. Poly(arylene sulfide) containing less than 100 percent —(Ar—S)— can further comprise units having one or more of the following structures, wherein (*) as used throughout the disclosure represents a continuing portion of a polymer chain or terminal group:

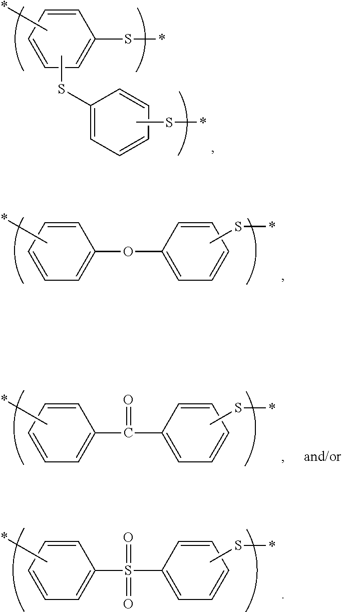

In an embodiment, the arylene sulfide unit can be represented by Formula I.

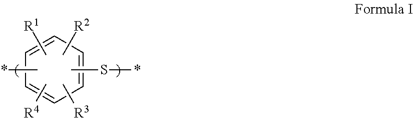

It should be understood, that within the arylene sulfide unit having Formula I, the relationship between the position of the sulfur atom of the arylene sulfide unit and the position where the next arylene sulfide unit can be ortho, meta, para, or any combination thereof. Generally, the identity of R¹, R², R³, and R⁴ are independent of each other and can be any group described herein.

In an embodiment, R¹, R², R³, and R⁴ independently can be hydrogen or a substituent. In some embodiments, each substituent independently can be an organyl group, an organocarboxy group, or an organothio group; alternatively, an organyl group or an organocarboxy group; alternatively, an organyl group or an organothio group; alternatively, an organyl group; alternatively, an organocarboxy group; or alternatively, or an organothio group. In other embodiments, each substituent independently can be a hydrocarbyl group, a hydrocarboxy group, or a hydrocarbylthio group; alternatively, a hydrocarbyl group or a hydrocarboxy group; alternatively, a hydrocarbyl group or a hydrocarbylthio group; alternatively, a hydrocarbyl group; alternatively, a hydrocarboxy group; or alternatively, or a hydrocarbylthio group. In yet other embodiments, each substituent independently can be an alkyl group, an alkoxy group, or an alkylthio group; alternatively, an alkyl group or an alkoxy group; alternatively, an alkyl group or an alkylthio group; alternatively, an alkyl group; alternatively, an alkoxy group; or alternatively, or an alkylthio group.

In an embodiment, each organyl group which can be utilized as R¹, R², R³, and/or R⁴ independently can be a C₁ to C₂₀ organyl group; alternatively, a C₁ to C₁₀ organyl group; or alternatively, a C₁ to C₅ organyl group. In an embodiment, each organocarboxy group which can be utilized as R¹, R², R³, and/or R⁴ independently can be a C₁ to C₂₀ organocarboxy group; alternatively, a C₁ to C₁₀ organocarboxy group; or alternatively, a C₁ to C₅ organocarboxy group. In an embodiment, each organothio group which can be utilized as R¹, R², R³, and/or R⁴ independently can be a C₁ to C₂₀ organothio group; alternatively, a C₁ to C₁₀ organothio group; or alternatively, a C₁ to C₅ organothio group. In an embodiment, each hydrocarbyl group which can be utilized as R¹, R², R³, and/or R⁴ independently can be a C₁ to C₂₀ hydrocarbyl group; alternatively, a C₁ to C₁₀ hydrocarbyl group; or alternatively, a C₁ to C₅ hydrocarbyl group. In an embodiment, each hydrocarboxy group which can be utilized as R¹, R², R³, and/or R⁴ independently can be a C₁ to C₂₀ hydrocarboxy group; alternatively, a C₁ to C₁₀ hydrocarboxy group; or alternatively, a C₁ to C₅ hydrocarboxy group. In an embodiment, each hydrocarbyl group which can be utilized as R¹, R², R³, and/or R⁴ independently can be a C₁ to C₂₀ hydrocarbylthio group; alternatively, a C₁ to C₁₀ hydrocarbylthio group; or alternatively, a C₁ to C₅ hydrocarbylthio group. In an embodiment, each alkyl group which can be utilized as R¹, R², R³, and/or R⁴ independently can be a C₁ to C₂₀ alkyl group; alternatively, a C₁ to C₁₀ alkyl group; or alternatively, a C₁ to C₅ alkyl group. In an embodiment, each alkoxy group which can be utilized as R¹, R², R³, and/or R⁴ independently can be a C₁ to C₂₀ alkoxy group; alternatively, a C₁ to C₁₀ alkoxy group; or alternatively, a C₁ to C₅ alkoxy group. In an embodiment, each alkoxy group which can be utilized as R¹, R², R³, and/or R⁴ independently can be a C₁ to C₂₀ alkylthio group; alternatively, a C₁ to C₁₀ alkylthio group; or alternatively, a C₁ to C₅ alkylthio group.

In some embodiments, each non-hydrogen R¹, R², R³, and/or R⁴ independently can be an alkyl group, a substituted alkyl group, a cycloalkyl group, a substituted cycloalkyl group, an aryl group, a substituted aryl group, an aralkyl group, or a substituted aralkyl group. In other embodiments, each non-hydrogen R¹, R², R³, and/or R⁴ independently can be an alkyl group or a substituted alkyl group; alternatively, a cycloalkyl group or a substituted cycloalkyl group; alternatively, an aryl group or a substituted aryl group; or alternatively, an aralkyl group or a substituted aralkyl group. In yet other embodiments, each non-hydrogen R¹, R², R³, and/or R⁴ independently can be an alkyl group; alternatively, a substituted alkyl group; alternatively, a cycloalkyl group; alternatively, a substituted cycloalkyl group; alternatively, an aryl group; alternatively, a substituted aryl group; alternatively, an aralkyl group; or alternatively, a substituted aralkyl group. Generally, the alkyl group, substituted alkyl group, cycloalkyl group, substituted cycloalkyl group, aryl group, substituted aryl group, aralkyl group, and substituted aralkyl group which can be utilized as R can have the same number of carbon atoms as any organyl group or hydrocarbyl group of which it is a member.

In an embodiment, each non-hydrogen R¹, R², R³, and/or R⁴ independently a methyl group, an ethyl group, a propyl group, a butyl group, a pentyl group, a hexyl group, a heptyl group, an octyl group, a nonyl group, or a decyl group. In some embodiments, each non-hydrogen R¹, R², R³, and/or R⁴ independently can be a methyl group, an ethyl group, a n-propyl group, an iso-propyl group, a n-butyl group, an iso-butyl group, a sec-butyl group, a tert-butyl group, an n-pentyl group, an iso-pentyl group, a sec-pentyl group, or a neopentyl group; alternatively, a methyl group, an ethyl group, an iso-propyl group, a tert-butyl group, or a neopentyl group; alternatively, a methyl group; alternatively, an ethyl group; alternatively, a n-propyl group; alternatively, an iso-propyl group; alternatively, a tert-butyl group; or alternatively, a neopentyl group. In some embodiments, any of the disclosed alkyl groups can be substituted. Substituents for the substituted alkyl group are independently disclosed herein and can be utilized without limitation to further describe the substituted alkyl group which can be utilized as a non-hydrogen R¹, R², R³, and/or R⁴.

In an aspect, each cycloalkyl group (substituted or unsubstituted) which can be utilized as a non-hydrogen R¹, R², R³, and/or R⁴ independently can be a C₄ to C₂₀ cycloalkyl group (substituted or unsubstituted); alternatively, a C₅ to C₁₅ cycloalkyl group (substituted or unsubstituted); or alternatively, a C₅ to C₁₀ cycloalkyl group (substituted or unsubstituted). In an embodiment, each non-hydrogen R¹, R², R³, and/or R⁴ independently can be a cyclobutyl group, a substituted cyclobutyl group, a cyclopentyl group, a substituted cyclopentyl group, a cyclohexyl group, a substituted cyclohexyl group, a cycloheptyl group, a substituted cycloheptyl group, a cyclooctyl group, or a substituted cyclooctyl group. In other embodiments, each non-hydrogen R¹, R², R³, and/or R⁴ independently can be a cyclopentyl group, a substituted cyclopentyl group, a cyclohexyl group, or a substituted cyclohexyl group; alternatively, a cyclopentyl group or a substituted cyclopentyl group; or alternatively, a cyclohexyl group or a substituted cyclohexyl group. In further embodiments, each non-hydrogen R¹, R², R³, and/or R⁴ independently can be a cyclopentyl group; alternatively, a substituted cyclopentyl group; a cyclohexyl group; or alternatively, a substituted cyclohexyl group. Substituents for the substituted cycloalkyl group are independently disclosed herein and can be utilized without limitation to further describe the substituted cycloalkyl group which can be utilized as a non-hydrogen R group. Substituents for the substituted cycloalkyl groups (general or specific) are independently disclosed herein and can be utilized without limitation to further describe the substituted cycloalkyl groups which can be utilized as a non-hydrogen R¹, R², R³, and/or R⁴.

In an aspect, the aryl group (substituted or unsubstituted) which can be utilized as a non-hydrogen R¹, R², R³, and/or R⁴ independently can be a C₆-C₂₀ aryl group (substituted or unsubstituted); alternatively, a C₆-C₁₅ aryl group (substituted or unsubstituted); or alternatively, a C₆-C₁₀ aryl group (substituted or unsubstituted). In an embodiment, each R¹, R², R³, and/or R⁴ independently can be a phenyl group, a substituted phenyl group, a naphthyl group, or a substituted naphthyl group. In an embodiment, each R¹, R², R³, and/or R⁴ independently can be a phenyl group or a substituted phenyl group; alternatively, a naphthyl group or a substituted naphthyl group; alternatively, a phenyl group or a naphthyl group; or alternatively, a substituted phenyl group or a substituted naphthyl group.

In an embodiment, each substituted phenyl group which can be utilized as a non-hydrogen R¹, R², R³, and/or R⁴ independently can be a 2-substituted phenyl group, a 3-substituted phenyl group, a 4-substituted phenyl group, a 2,4-disubstituted phenyl group, a 2,6-disubstituted phenyl group, a 3,5-disubstituted phenyl group, or a 2,4,6-trisubstituted phenyl group. In other embodiments, each substituted phenyl group which can be utilized as a non-hydrogen R¹, R², R³, and/or R⁴ independently can be a 2-substituted phenyl group, a 4-substituted phenyl group, a 2,4-disubstituted phenyl group, or a 2,6-disubstituted phenyl group; alternatively, a 3-substituted phenyl group or a 3,5-disubstituted phenyl group; alternatively, a 2-substituted phenyl group or a 4-substituted phenyl group; alternatively, a 2,4-disubstituted phenyl group or a 2,6-disubstituted phenyl group; alternatively, a 2-substituted phenyl group; alternatively, a 3-substituted phenyl group; alternatively, a 4-substituted phenyl group; alternatively, a 2,4-disubstituted phenyl group; alternatively, a 2,6-disubstituted phenyl group; alternatively, 3,5-disubstituted phenyl group; or alternatively, a 2,4,6-trisubstituted phenyl group. Substituents for the substituted phenyl groups (general or specific) are independently disclosed herein and can be utilized without limitation to further describe the substituted phenyl groups which can be utilized as a non-hydrogen R¹, R², R³, and/or R⁴.

Nonlimiting examples of suitable poly(arylene sulfide) polymers suitable for use in this disclosure include poly(2,4-toluene sulfide), poly(4,4′-biphenylene sulfide), poly(para-phenylene sulfide), poly(ortho-phenylene sulfide), poly(meta-phenylene sulfide), poly(xylene sulfide), poly(ethylisopropylphenylene sulfide), poly(tetramethylphenylene sulfide), poly(butylcyclohexylphenylene sulfide), poly(hexyldodecylphenylene sulfide), poly(octadecyl-phenylene sulfide), poly(phenylphenylene sulfide), poly(tolylphenylene sulfide), poly(benzyl-phenylene sulfide), poly[octyl-4-(3-methylcyclopentyl)phenylene sulfide], and any combination thereof.

In an embodiment the poly(arylene sulfide) polymer comprises poly(phenylene sulfide) or PPS. In an aspect, PPS is a polymer comprising at least about 70, 80, 90, or 95 mole percent para-phenylene sulfide units. In another embodiment, the poly(arylene sulfide) can contain up to about 50, 70, 80, 90, 95, or 99 mole percent para-phenylene sulfide units. In some embodiments, PPS can contain from any minimum mole percent of the para-phenylene sulfide unit disclosed herein to any maximum mole percent of the para-phenylene sulfide unit disclosed herein; for example, from about 70 to about 99 mole percent, alternatively, from about 70 to about 95 mole percent, or alternatively, from about 80 to about 95 mole percent of the —(Ar—S)— unit. Other suitable ranges for the para-phenylene sulfide units will be readily apparent to one of skill in the art with the help of this disclosure. The structure for the para-phenylene sulfide unit can be represented by Formula II.

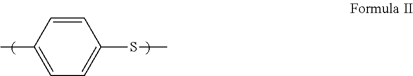

In an embodiment, PPS can comprise up to about 30, 20, 10, or 5 mole percent of one or more units selected from ortho-phenylene sulfide groups, meta-phenylene sulfide groups, substituted phenylene sulfide groups, phenylene sulfone groups, substituted phenylene sulfide groups, or groups having the following structures:

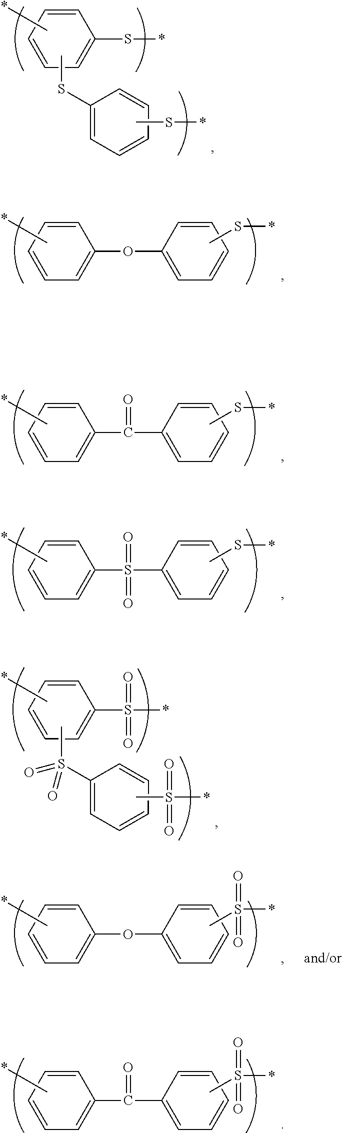

In other embodiments, PPS can comprise up to about 30, 20, 10, or 5 mole percent of units having one or more of the following structures:

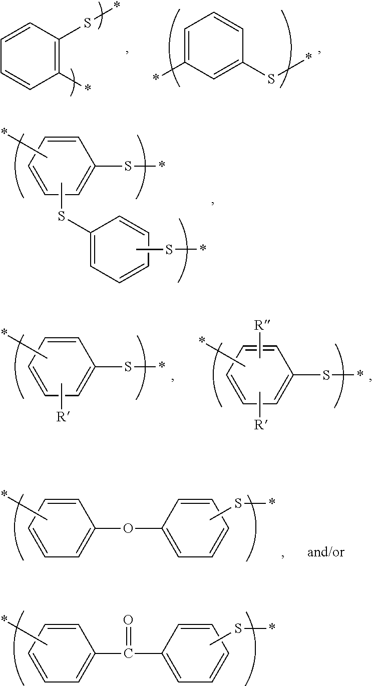

wherein R′ and R″ can be independently selected from any arylene substituent group disclosed herein for a poly(arylene sulfide). In other embodiments, PPS can comprise up to about 30, 20, 10, or 5 mole percent of units having one or more of the following structures:

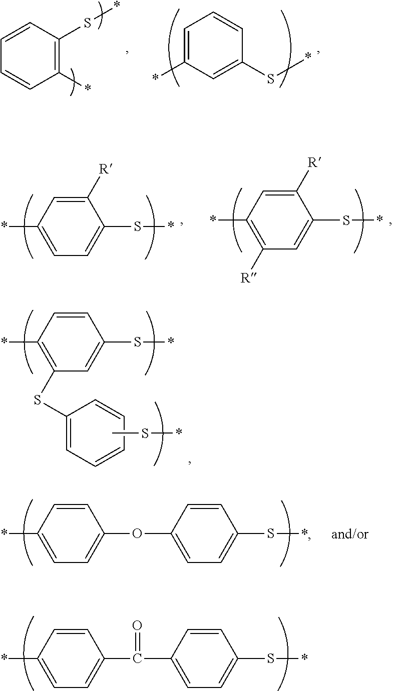

wherein R′ and R″ can be independently selected from any arylene substituent group disclosed herein for a poly(arylene sulfide). In other embodiments, PPS can comprise up to about 30, 20, 10, or 5 mole percent of units having one or more of the following structures:

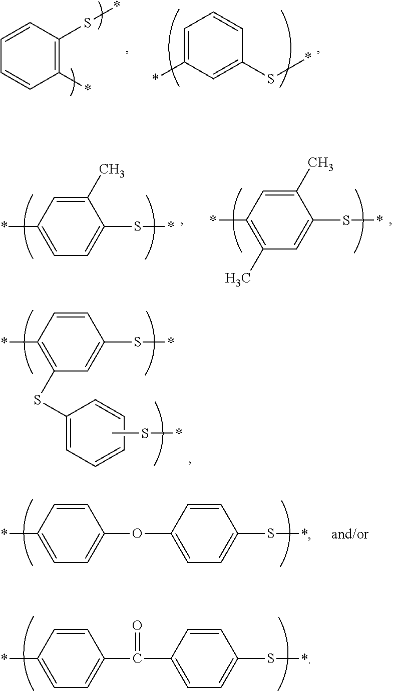

The PPS molecular structure can readily form a thermally stable crystalline lattice, giving PPS a semi-crystalline morphology with a high crystalline melting point ranging from about 265° C. to about 315° C. Because of its molecular structure, PPS also can tend to char during combustion, making the material inherently flame resistant. Further, PPS can not typically dissolve in solvents at temperatures below about 200° C.

PPS is manufactured and sold under the trade name Ryton® PPS by Chevron Phillips Chemical Company LP of The Woodlands, Tex. Other sources of poly(phenylene sulfide) include Ticona, Toray, and Dainippon Ink and Chemicals, Incorporated, among others.

Generally, a poly(arylene sulfide) can be produced by contacting at least one halogenated aromatic compound having two halogens, a sulfur compound, and a polar organic compound to form the poly(arylene sulfide). In an embodiment, the process to produce the poly(arylene sulfide) can further comprise recovering the poly(arylene sulfide). In some embodiments, the polyarylene sulfide can be formed under polymerization conditions capable of producing the poly(arylene sulfide). In an embodiment, the poly(arylene sulfide) can be produced in the presence of a halogenated aromatic compound having greater than two halogen atoms (e.g., 1,2,4,-trichlorobenzene, among others).

Similarly, PPS can be produced by contacting at least one para-dihalobenzene compound, a sulfur compound, and a polar organic compound to form the PPS. In an embodiment, the process to produce the PPS can further comprise recovering the PPS. In some embodiments, the PPS can be formed under polymerization conditions capable of forming the PPS. When producing PPS, other dihaloaromatic compounds can also be present so long as the produced PPS conforms to the PPS desired features. For example, in an embodiment, the PPS can be prepared utilizing substituted para-dihalobenzene compounds and/or halogenated aromatic compounds having greater than two halogen atoms (e.g., 1,2,4-trichlorobenzene or substituted or a substituted 1,2,4-trichlorobenzene, among others). Methods of PPS production are described in more detail in U.S. Pat. Nos. 3,919,177; 3,354,129; 4,038,261; 4,038,262; 4,038,263; 4,064,114; 4,116,947; 4,282,347; 4,350,810; and 4,808,694; each of which is incorporated by reference herein in its entirety.

In an embodiment, halogenated aromatic compounds having two halogens which can be employed to produce the poly(arylene sulfide) can be represented by Formula III.

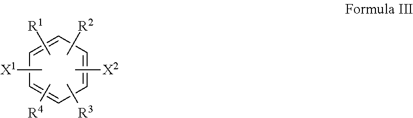

In an embodiment, X¹ and X² independently can be a halogen. In some embodiments, each X¹ and X² independently can be fluorine, chlorine, bromine, iodine; alternatively, chlorine, bromine, or iodine; alternatively, chlorine; alternatively, bromine; or alternatively, iodine. R¹, R², R³ and R⁴ have been described previously herein for the poly(arylene sulfide) having Formula I. Any aspect and/or embodiment of these R¹, R², R³, and R⁴ descriptions can be utilized without limitation to describe the halogenated aromatic compounds having two halogens represented by Formula III. It should be understood, that for producing poly(arylene sulfide)s, the relationship between the position of the halogens X¹ and X² can be ortho, meta, para, or any combination thereof; alternatively, ortho; alternatively, meta; or alternatively, para. Examples of halogenated aromatic compounds having two halogens that can be utilized to produce a poly(arylene sulfide) can include, but not limited to, dichlorobenzene (ortho, meta, and/or para), dibromobenzene (ortho, meta, and/or para), diiodobenzene (ortho, meta, and/or para), chlorobromobenzene (ortho, meta, and/or para), chloroiodobenzene (ortho, meta, and/or para), bromoiodobenzene (ortho, meta, and/or para), dichlorotoluene, dichloroxylene, ethylisopropyldibromobenzene, tetramethyldichlorobenzene, butylcyclohexyldibromobenzene, hexyldodecyldichlorobenzene, octadecyldiidobenzene, phenylchlorobromobenzene, tolyldibromobenzene, benzyldichloro-benzene, octylmethylcyclopentyldichlorobenzene, or any combination thereof.

The para-dihalobenzene compound which can be utilized to produce poly(phenylene sulfide) can be any para-dihalobenzene compound. In an embodiment, para-dihalobenzenes that can be used in the synthesis of PPS can be, comprise, or consist essentially of, p-dichlorobenzene, p-dibromobenzene, p-diiodobenzene, 1-chloro-4-bromobenzene, 1-chloro-4-iodobenzene, 1-bromo-4-iodobenzene, or any combination thereof. In some embodiments, the para-dihalobenzene that can be used in the synthesis of PPS can be, comprise, or consist essentially of, p-dichlorobenzene.

In some embodiments, the synthesis of the PPS can further include 2,5-dichlorotoluene, 2,5-dichloro-p-xylene, 1-ethyl-4-isopropyl-2,5-dibromobenzene, 1,2,4,5-tetramethyl-3,6-dichlorobenzene, 1-butyl-4-cyclohexyl-2,5-dibromobenzene, 1-hexyl-3-dodecyl-2,5-dichlorobenzene, 1-octadecyl-2,5-diidobenzene, 1-phenyl-2-chloro-5-bromobenzene, 1-(p-tolyl)-2,5-dibromobenzene, 1-benzyl-2,5-dichlorobenzene, 1-octyl-4-(3-methylcyclopentyl)-2,5-dichlorobenzene, or combinations thereof.

Without wishing to be limited by theory, sulfur sources which can be employed in the synthesis of the poly(arylene sulfide) can include thiosulfates, thioureas, thioamides, elemental sulfur, thiocarbamates, metal disulfides and oxysulfides, thiocarbonates, organic mercaptans, organic mercaptides, organic sulfides, alkali metal sulfides and bisulfides, hydrogen sulfide, or any combination thereof. In an embodiment, an alkali metal sulfide can be used as the sulfur source. Alkali metal sulfides suitable for use in the present disclosure can be, comprise, or consist essentially of, lithium sulfide, sodium sulfide, potassium sulfide, rubidium sulfide, cesium sulfide, or any combination thereof. In some embodiments, the alkali metal sulfides that can be employed in the synthesis of the poly(arylene sulfide) can be an alkali metal sulfide hydrate or an aqueous alkali metal sulfide solution; alternatively, an alkali metal sulfide hydrate; or alternatively, an aqueous alkali metal sulfide solution. Aqueous alkali metal sulfide solution can be prepared by any suitable methodology. In an embodiment, the aqueous alkali metal sulfide solution can be prepared by the reaction of an alkali metal hydroxide with an alkali metal bisulfide in water; or alternatively, prepared by the reaction of an alkali metal hydroxide with hydrogen sulfide (H₂S) in water. Other sulfur sources suitable for use in the present disclosure are described in more detail in U.S. Pat. No. 3,919,177, which is incorporated by reference herein in its entirety.

In an embodiment, a process for the preparation of poly(arylene sulfide) can utilize a sulfur source which can be, comprise, or consist essentially of, an alkali metal bisulfide. In such embodiments, a reaction mixture for preparation of the poly(arylene sulfide) can comprise a base. In such embodiments, alkali metal hydroxides, such as sodium hydroxide (NaOH) can be utilized. In such embodiments, it can be desirable to reduce the alkalinity of the reaction mixture prior to termination of the polymerization reaction. Without wishing to be limited by theory, a reduction in alkalinity of the reaction mixture can result in the formation of a reduced amount of ash-causing polymer structures. The alkalinity of the reaction mixture can be reduced by any suitable methodology, for example by the addition of an acidic solution prior to termination of the polymerization reaction.

In an embodiment, the sulfur source suitable for use in the production of poly(arylene sulfide) can be prepared by combining sodium hydrosulfide (NaSH) and sodium hydroxide (NaOH) in an aqueous solution followed by dehydration (or alternatively, by combining an alkali metal hydroxide with hydrogen sulfide (H₂S)). The production of Na₂S in this manner can be considered to be an equilibrium between Na₂S, water (H₂O), NaSH, and NaOH according to the following equation.

Na₂S+H₂O [symbol] NaSH+NaOH

The resulting sulfur source can be referred to as sodium sulfide (Na₂S). In another embodiment, the production of Na₂S can be performed in the presence of the polar organic solvent, e.g., N-methyl-2-pyrrolidone (NMP), among others disclosed herein. Without being limited to theory, when the sulfur compound (e.g., sodium sulfide) is prepared by reacting NaSH with NaOH in the presence of water and N-methyl-2-pyrrolidone, the N-methyl-2-pyrrolidone can also react with the sodium hydroxide (e.g., aqueous sodium hydroxide) to produce a mixture containing sodium hydrosulfide and sodium N-methyl-4-aminobutanoate (SMAB). Stoichiometrically, the overall reaction equilibrium can appear to follow the equation:

NMP+Na₂S+H₂O [symbol] CH₃NH₂CH₂CH₂CH₂CO₂Na(SMAB)+NaSH

However, it should be noted that this equation is a simplification and, in actuality, the equilibrium between Na₂S, H₂O, NaOH, and NaSH, and the water-mediated ring opening of NMP by sodium hydroxide can be significantly more complex.

The polar organic compound which can be utilized in the preparation of a poly(arylene sulfide) can comprise a polar organic compound which can function to keep the dihaloaromatic compounds, sulfur source, and growing poly(arylene sulfide) in solution during the polymerization. In an aspect, the polar organic compound can be, comprise, or consist essentially of, an amide, a lactam, a sulfone, or any combinations thereof; alternatively, an amide; alternatively, a lactam; or alternatively, a sulfone. In an embodiment, the polar organic compound can be, comprise, or consist essentially of, hexamethylphosphoramide, tetramethylurea, N,N-ethylenedipyrrolidone, N-methyl-2-pyrrolidone, pyrrolidone, caprolactam, N-ethylcaprolactam, sulfolane, N,N′-dimethylacetamide, 1,3-dimethyl-2-imidazolidinone, low molecular weight polyamides, or combinations thereof. In an embodiment, the polar organic compound can be, comprise, or consist essentially of, N-methyl-2-pyrrolidone. Additional polar organic compounds suitable for use in the present disclosure are described in more detail in D. R. Fahey and J. F. Geibel, Polymeric Materials Encyclopedia, Vol. 8, (Boca Raton, CRC Press, 1996), pages 6506-6515, which is incorporated by reference herein in its entirety.

In an embodiment, processes for the preparation of a poly(arylene sulfide) can employ one or more additional reagents. For example, molecular weight modifying or enhancing agents such as alkali metal carboxylates, lithium halides, or water can be added or produced during polymerization. In an embodiment, a reaction mixture for preparation of a poly(arylene sulfide) can further comprise an alkali metal carboxylate.

Alkali metal carboxylates which can be employed include, without limitation, those having general formula R′CO₂M where R′ can be a C₁ to C₂₀ hydrocarbyl group, a C₁ to C₂₀ hydrocarbyl group, or a C₁ to C₅ hydrocarbyl group. In some embodiments, R′ can be an alkyl group, a cycloalkyl group, an aryl group, aralkyl group; or alternatively, an alkyl group. Alkyl groups, cycloalkyl groups, aryl groups, aralkyl groups are disclosed herein (e.g., as options for R¹, R², R³, and R⁴ or a substituent groups). These alkyl groups, cycloalkyl groups, aryl groups, aralkyl groups can be utilized without limitation to further describe R′ of the alkali metal carboxylates having the formula R′CO₂M. In an embodiment, M can be an alkali metal. In some embodiments, the alkali metal can be, comprise, or consist essentially of, lithium, sodium, potassium, rubidium, or cesium; alternatively, lithium; alternatively, sodium; or alternatively, potassium. The alkali metal carboxylate can be employed as a hydrate; or alternatively, as a solution or dispersion in water. In an embodiment, the alkali metal carboxylate can be, comprise, or consist essentially of, sodium acetate (NaOAc or NaC₂H₃O₂).

General conditions for the production of poly(arylene sulfides) are generally described in U.S. Pat. Nos. 5,023,315; 5,245,000; 5,438,115; and 5,929,203; each of which is incorporated by reference herein in its entirety. Although specific mention can be made in this disclosure and the disclosures incorporated by reference herein to material produced using the “quench” termination process, it is contemplated that other processes (e.g., “flash” termination process) can be employed for the preparation of a poly(arylene sulfide) (e.g., PPS). It is contemplated that a poly(arylene sulfide) obtained from a process other than the quench termination process can be suitably employed in the methods and compositions of this disclosure.

Generally, the ratio of reactants employed in the polymerization process to produce a poly(arylene sulfide) can vary widely. However, the typical equivalent ratio of the halogenated aromatic compound having two halogens to sulfur compound can be in the range of from about 0.8 to about 2; alternatively, from about 0.9 to about 1.5; or alternatively, from about 0.95 to about 1.3. The amount of polyhalo-substituted aromatic compound optionally employed as a reactant can be any amount to achieve the desired degree of branching to give the desired poly(arylene sulfide) melt flow. Generally, up to about 0.02 moles of polyhalo-substituted aromatic compound per mole of halogenated aromatic compound having two halogens can be employed. If an alkali metal carboxylate is employed as a molecular weight modifying agent, the mole ratio of alkali metal carboxylate to dihaloaromatic compound(s) can be within the range of from about 0.02 to about 4; alternatively, from about 0.05 to about 3; or alternatively, from about 0.1 to about 2.

The amount of polar organic compound employed in the process to prepare the poly(arylene sulfide) can vary over a wide range during the polymerization. However, the molar ratio of polar organic compound to the sulfur compound is typically within the range of from about 1 to about 10. If a base, such as sodium hydroxide, is contacted with the polymerization reaction mixture, the molar ratio is generally in the range of from about 0.5 to about 4 moles per mole of sulfur compound.

The components of the reaction mixture can be contacted with each other in any order. Some of the water, which can be introduced with the reactants, can be removed prior to polymerization. In some instances, the water can be removed in a dehydration process. For example, in instances where a significant amount of water is present (e.g., more than about 0.3 moles of water per mole of sulfur compound) water can be removed in a dehydration process. The temperature at which the polymerization can be conducted can be within the range of from about 170° C. (347° F.) to about 450° C. (617° F.); or alternatively, within the range of from about 200° C. (392° F.) to about 285° C. (545° F.). The reaction time can vary widely, depending, in part, on the reaction temperature, but is generally within the range of from about 10 minutes to about 3 days; or alternatively, within a range of from about 1 hour to about 8 hours. The reactor pressure need be only sufficient to maintain the polymerization reaction mixture substantially in the liquid phase. Such pressure will can be in the range of from about 0 psig to about 400 psig; alternatively, in the range of from about 30 psig to about 300 psig; or alternatively, in the range of from about 100 psig to about 250 psig.

The polymerization can be terminated by cooling the reaction mixture (removing heat) to a temperature below that at which substantial polymerization takes place. In some instances the cooling of the reaction mixture also begins the process to recover the poly(arylene sulfide) as the poly(arylene sulfide) can precipitate from solution at temperatures less than about 235° C. Depending upon the polymerization features (temperature, solvent(s), and water quantity, among other features) and the methods employed to cool the reaction mixture, the poly(arylene sulfide) can begin to precipitate from the reaction solution at a temperature ranging from about 235° C. to about 185° C. Generally, poly(arylene sulfide) precipitation can impede further polymerization.

The poly(arylene sulfide) reaction mixture can be cooled using a variety of methods. In an embodiment, the polymerization can be terminated by the flash evaporation of the solvent (e.g., the polar organic compound, water, or a combination thereof) from the poly(arylene sulfide) reaction mixture. Processes for preparing poly(arylene sulfide) utilizing solvent flash evaporation to terminate the reaction can be referred to as a flash termination process. In other embodiments, the polymerization can be terminated by adding a liquid comprising, or consisting essentially of, 1) water, 2) polar organic compound, or 3) a combination of water and polar organic compound (alternatively water; or alternatively, polar organic compound) to the poly(arylene sulfide) reaction mixture and cooling the poly(arylene sulfide) reaction mixture. In yet other embodiments, the polymerization can be terminated by adding a solvent(s) other than water or the polar organic compound to the poly(arylene sulfide) reaction mixture and cooling the poly(arylene sulfide) reaction mixture. Processes for preparing poly(arylene sulfide) which utilize the addition of water, polar organic compound, and/or other solvent(s) to terminate the reaction can be referred to as a quench termination process. The cooling of the reaction mixture can be facilitated by the use of reactor jackets or coil. Another method for terminating the polymerization can include contacting the reaction mixture with a polymerization inhibiting compound. It should be noted that termination of the polymerization does not imply that complete reaction of the polymerization components has occurred. Moreover, termination of the polymerization is not meant to imply that no further polymerization of the reactants can take place. Generally, for economic reasons, termination (and poly(arylene sulfide) recovery) can be initiated at a time when polymerization is substantially complete or when further reaction would not result in a significant increase in polymer molecular weight.

In an embodiment, a process for the production of a poly(arylene sulfide) polymer can comprise a step of processing the poly(arylene sulfide) reaction mixture to obtain a poly(arylene sulfide) polymer and a by-product slurry. In such embodiment, the step of processing the poly(arylene sulfide) reaction mixture can comprise washing the poly(arylene sulfide) reaction mixture with a polar organic compound and/or water to obtain a raw poly(arylene sulfide) polymer and a first slurry; treating at least a portion of the raw poly(arylene sulfide) polymer with an aqueous acid solution and/or an aqueous metal cation solution to obtain a treated poly(arylene sulfide) polymer; drying at least a portion of the raw poly(arylene sulfide) polymer and/or treated poly(arylene sulfide) polymer to obtain a dried poly(arylene sulfide) polymer; and evaporating a portion of the first slurry to obtain a by-product slurry, wherein the by-product slurry comprises slurry particulates.

In an embodiment, a process for the production of a poly(arylene sulfide) polymer can comprise a step of washing the poly(arylene sulfide) reaction mixture with a polar organic compound and/or water to obtain a raw poly(arylene sulfide) polymer and a first slurry. In an embodiment, a washing vessel can receive the poly(arylene sulfide) reaction mixture (e.g., the poly(arylene sulfide) reaction mixture can be introduced to a washing vessel), wherein the poly(arylene sulfide) reaction mixture can be washed with a polar organic compound and/or water to obtain a raw poly(arylene sulfide) polymer and a first slurry. As will be appreciated by one of skill in the art, more than one washing vessel can be used for washing the poly(arylene sulfide) reaction mixture, such as for example two, three, four, five, six, or more washing vessels can be used for washing the poly(arylene sulfide) reaction mixture.

Once the poly(arylene sulfide) has precipitated from solution, a particulate poly(arylene sulfide) can be recovered from the reaction mixture slurry by any process capable of separating a solid precipitate from a liquid. For purposes of the disclosure herein, the recovered particulate poly(arylene sulfide) will be referred to as “raw particulate poly(arylene sulfide) polymer,” “raw particulate poly(arylene sulfide),” “raw poly(arylene sulfide) polymer,” or simply “raw poly(arylene sulfide),” (e.g., “raw PPS”). It should be noted that the process to produce the poly(arylene sulfide) can form a by-product alkali metal halide. The by-product alkali metal halide can be removed during process steps utilized to recover the raw poly(arylene sulfide) (e.g., raw PPS). Procedures which can be utilized to recover the raw poly(arylene sulfide) from the reaction mixture slurry can include, but are not limited to, i) filtration, ii) washing the raw poly(arylene sulfide) with a liquid (e.g., water or aqueous solution), or iii) dilution of the reaction mixture with liquid (e.g., water or aqueous solution) followed by filtration and washing the raw poly(arylene sulfide) with a liquid (e.g., water or aqueous solution). For example, in a non-limiting embodiment, the reaction mixture slurry can be filtered to recover the raw poly(arylene sulfide) (e.g., the raw PPS) polymer (containing poly(arylene sulfide) or PPS, and by-product alkali metal halide), which can be slurried in a liquid (e.g., water or aqueous solution) and subsequently filtered to remove the alkali metal halide by-product (and/or other liquid, e.g., water, soluble impurities). Generally, the steps of slurrying the raw poly(arylene sulfide) with a liquid followed by filtration to recover the raw poly(arylene sulfide) can occur as many times as necessary to obtain a desired level of purity of the raw poly(arylene sulfide).

In an embodiment, the procedures utilized to recover the raw poly(arylene sulfide) from the reaction mixture can also yield a liquid phase. For purposes of the disclosure herein, such liquid phase will be referred to as “first slurry.” In an embodiment, the first slurry can comprise water, a polar organic compound (e.g., NMP), an alkali metal halide by-product (e.g., salt, NaCl, etc.), poly(arylene sulfide) polymer impurities (e.g., poly(arylene sulfide) fines, poly(arylene sulfide) oligomers, poly(arylene sulfide) low molecular weight polymers), a halogenated aromatic compound (e.g., p-dichlorobenzene), a molecular weight modifying agent (e.g., an alkali metal carboxylate, sodium acetate), and the like. As will be appreciated by one of skill in the art, and with the help of this disclosure, while the first slurry is the liquid phase obtained during one or more filtration processes to recover the raw poly(arylene sulfide), some insoluble particulates can pass through a filtering device (e.g., a filter, a screen, a sieve, etc.) and be present in such liquid phase (e.g., filtrate), thereby making the liquid phase a slurry. Further, as will be appreciated by one of skill in the art, and with the help of this disclosure, the first slurry can be a very diluted slurry, based on the amount of liquid present in the reaction mixture and the amount of liquid used to wash the poly(arylene sulfide) during the recovery of the raw poly(arylene sulfide). Further, as will be appreciated by one of skill in the art, and with the help of this disclosure, the amount and type of liquid present in the first slurry influences the solubility of components of the first slurry, and some slurry components (e.g., salts, NaCl, alkali metal carboxylates, sodium acetate, etc.) can be partially soluble in the first slurry, e.g., a portion of a slurry component can be present in the first slurry as a dissolved component, while another portion of the same slurry component can be present in the first slurry as a solid particle.

In an embodiment, the first slurry can be subjected to further processing, such as for example to recover the polar organic compound, as will be described in detail later herein. The recovered polar organic compound (e.g., recovered NMP) can be recycled/reused in a subsequent polymerization process for the production of poly(arylene sulfide) (e.g., PPS).

In an embodiment, a process for the production of a poly(arylene sulfide) polymer can comprise a step of treating at least a portion of the raw poly(arylene sulfide) polymer with an aqueous acid solution and/or an aqueous metal cation solution (e.g., post recovery processing) to obtain a treated poly(arylene sulfide) polymer.

In an embodiment, the raw poly(arylene sulfide) can undergo post recovery processing. For example, the raw poly(arylene sulfide) can be treated with an aqueous acid solution and/or can be treated with an aqueous metal cation solution, to yield treated poly(arylene sulfide) (e.g., acid treated poly(arylene sulfide), metal cation treated poly(arylene sulfide)). Additionally, the raw poly(arylene sulfide) can be dried to remove liquid adhering to the raw particulate poly(arylene sulfide) (e.g., raw PPS) polymer. Generally, the raw poly(arylene sulfide) which can undergo post recovery processing can be i) the raw poly(arylene sulfide) recovered from the reaction mixture or ii) the raw poly(arylene sulfide) (e.g., raw PPS) which has been washed with a liquid (e.g., water) and filtered to remove the alkali metal halide by-product (and/or other liquid soluble impurities). The raw poly(arylene sulfide) which can undergo post recovery processing can either be liquid wet or dry; alternatively, liquid wet; or alternatively, dry.

Acid treatment can comprise a) contacting the raw poly(arylene sulfide) with water to form a poly(arylene sulfide) slurry, b) contacting the poly(arylene sulfide) slurry with an acidic compound to form an acidic mixture, c) heating the acidic mixture in substantial absence of a gaseous oxidizing atmosphere to an elevated temperature below the melting point of the poly(arylene sulfide), and d) recovering an acid treated poly(arylene sulfide) (e.g., an acid treated PPS); or alternatively, a) contacting the raw poly(arylene sulfide) with aqueous solution comprising an acidic compound to form an acidic mixture, b) heating the acidic mixture in substantial absence of a gaseous oxidizing atmosphere to an elevated temperature below the melting point of the poly(arylene sulfide), and c) recovering an acid treated poly(arylene sulfide) (e.g., acid treated PPS). The acidic compound can be any organic acid or inorganic acid which is water soluble under the conditions of the acid treatment; alternatively, an organic acid which is water soluble under the conditions of the acid treatment; or alternatively, an inorganic acid which is water soluble under the conditions of the acid treatment. Generally, the organic acid which can be utilized in the acid treatment can be any organic acid which is water soluble under the conditions of the acid treatment. In an embodiment, the organic acid which can be utilized in the acid treatment process can comprise, or consist essentially of, a C₁ to C₁₅ carboxylic acid; alternatively, a C₁ to C₁₀ carboxylic acid; or alternatively, a C₁ to C₅ carboxylic acid. In an embodiment, the organic acid which can be utilized in the acid treatment process can comprise, or consist essentially of, acetic acid, formic acid, oxalic acid, fumaric acid, and monopotassium phthalic acid; alternatively, acetic acid; alternatively, formic acid; alternatively, oxalic acid; or alternatively, fumaric acid. Inorganic acids which can be utilized in the acid treatment process can comprise, or consist essentially of, hydrochloric acid, monoammonium phosphate, sulfuric acid, phosphoric acid, boric acid, nitric acid, sodium dihydrogen phosphate, ammonium dihydrogen phosphate, carbonic acid, and sulfurous acid; alternatively, hydrochloric acid; alternatively, sulfuric acid; alternatively, phosphoric acid; alternatively, boric acid; or alternatively, nitric acid. The amount of the acidic compound present in the mixture (e.g., acidic mixture) can range from 0.01 wt. % to 10 wt. %, from 0.025 wt. % to 5 wt. %, or from 0.075 wt. % to 1 wt. % based on total amount of water in the mixture (e.g., acidic mixture). The amount of poly(arylene sulfide) present in the mixture (e.g., acidic mixture) can range from about 1 wt. % to about 50 wt. %, from about 5 wt. % to about 40 wt. %, or from about 10 wt. % to about 30 wt. %, based upon the total weight of the mixture (e.g., acidic mixture). Generally, the elevated temperature below the melting point of the poly(arylene sulfide) can range from about 165° C. to about 10° C., from about 150° C. to about 15° C., or from about 125° C. to about 20° C. below the melting point of the poly(arylene sulfide); or alternatively, can range from about 175° C. to about 275° C., or from about 200° C. to about 250° C. Additional features of the acid treatment process are described in more detail in U.S. Pat. No. 4,801,644, which is incorporated by reference herein in its entirety.

Generally, the metal cation treatment can comprise a) contacting the raw poly(arylene sulfide) with water to form a poly(arylene sulfide) slurry, b) contacting the poly(arylene sulfide) slurry with a Group 1 or Group 2 metal compound to form a metal cation mixture, c) heating the metal cation mixture in substantial absence of a gaseous oxidizing atmosphere to an elevated temperature below the melting point of the poly(arylene sulfide), and d) recovering a metal cation treated poly(arylene sulfide) (e.g., metal cation treated PPS); or alternatively, a) contacting the poly(arylene sulfide) with an aqueous solution comprising a Group 1 or Group 2 metal compound to form a metal cation mixture, b) heating the metal cation mixture in substantial absence of a gaseous oxidizing atmosphere to an elevated temperature below the melting point of the poly(arylene sulfide), and c) recovering a metal cation treated poly(arylene sulfide) (e.g., metal cation treated PPS). The Group 1 or Group 2 metal compound can be any organic Group 1 or Group 2 metal compound or inorganic Group 1 or Group 2 metal compound which is water soluble under the conditions of the metal cation treatment; alternatively, an organic Group 1 or Group 2 metal compound which is water soluble under the conditions of the metal cation treatment; or alternatively, an inorganic Group 1 or Group 2 metal compound which is water soluble under the conditions of the metal cation treatment. Organic Group 1 or Group 2 metal compounds which can be utilized in the metal cation treatment process can comprise, or consist essentially of, a Group 1 or Group 2 metal C₁ to C₁₅ carboxylate; alternatively, a Group 1 or Group 2 metal C₁ to C₁₀ carboxylate; or alternatively, a Group 1 or Group 2 metal C₁ to C₅ carboxylate (e.g., formate, acetate). Inorganic Group 1 or Group 2 metal compounds which can be utilized in the metal cation treatment process can comprise, or consist essentially of, a Group 1 or Group 2 metal oxide or hydroxide (e.g., calcium oxide or calcium hydroxide). The amount of the Group 1 or Group 2 metal compound present in the mixture (e.g., metal cation mixture) can range from about 50 ppm to about 10,000 ppm, from about 75 ppm to about 7,500 ppm, or from about 100 ppm to about 5,000 ppm. Generally, the amount of the Group 1 or Group 2 metal compound is by the total weight of the mixture (e.g., metal cation mixture). The amount of poly(arylene sulfide) present in the mixture (e.g., metal cation mixture) can range from about 10 wt. % to about 60 wt. %, from about 15 wt. % to about 55 wt. %, or from about 20 wt. % to about 50 wt. %, based upon the total weight of the mixture (e.g., metal cation mixture). Generally, the elevated temperature below the melting point of the poly(arylene sulfide) can range from about 165° C. to about 10° C., from about 150° C. to about 15° C., or from about 125° C. to about 20° C. below the melting point of the poly(arylene sulfide); or alternatively, can range from about 125° C. to about 275° C., or from about 150° C. to about 250° C. Additional features of the acid treatment process are provided in EP patent publication 0103279 A1, which is incorporated by reference herein in its entirety.

Once the poly(arylene sulfide) has been acid treated and/or metal cation treated, the acid treated and/or metal cation treated poly(arylene sulfide) can be recovered, to yield a recovered poly(arylene sulfide) polymer. Generally, the process/steps for recovering the acid treated and/or metal cation treated poly(arylene sulfide) can be the same steps as those for recovering and/or isolating the raw poly(arylene sulfide) from the reaction mixture.

Once the poly(arylene sulfide) has been recovered (either in raw, acid treated, metal cation treated, or acid treated and metal cation treated form), the recovered poly(arylene sulfide) (e.g., recovered PPS) can be dried and optionally cured. In an embodiment, a process for the production of a poly(arylene sulfide) polymer can comprise the step of drying at least a portion of the raw poly(arylene sulfide) polymer and/or treated poly(arylene sulfide) polymer to obtain a dried poly(arylene sulfide) polymer.

Generally, the poly(arylene sulfide) (e.g., recovered poly(arylene sulfide)) drying process can be performed at any temperature which can substantially dry the poly(arylene sulfide), to yield a dried poly(arylene sulfide) polymer. The drying process should result in substantially no oxidative curing of the poly(arylene sulfide). For example, if the drying process is conducted at a temperature of or above about 100° C., the drying should be conducted in a substantially non-oxidizing atmosphere (e.g., in a substantially oxygen free atmosphere or at a pressure less than atmospheric pressure, for example under vacuum). When the drying process is conducted at a temperature below about 100° C., the drying process can be facilitated by performing the drying at a pressure less than atmospheric pressure so the liquid component can be vaporized from the poly(arylene sulfide). When the poly(arylene sulfide) drying is performed below about 100° C., the presence of a gaseous oxidizing atmosphere will generally not result in a detectable curing of the poly(arylene sulfide). Generally, air is considered to be a gaseous oxidizing atmosphere.

Poly(arylene sulfide) can be cured by subjecting the poly(arylene sulfide) to an elevated temperature, below its melting point, in the presence of gaseous oxidizing atmosphere, thereby forming cured poly(arylene sulfide) (e.g., cured PPS). Any suitable gaseous oxidizing atmosphere can be used. For example, suitable gaseous oxidizing atmospheres include, but are not limited to, oxygen, any mixture of oxygen and an inert gas (e.g., nitrogen), or air; or alternatively air. The curing temperature can range from about 1° C. to about 130° C. below the melting point of the poly(arylene sulfide), from about 10° C. to about 110° C. below the melting point of the poly(arylene sulfide), or from about 30° C. to about 85° C. below the melting point of the poly(arylene sulfide). Agents that affect curing, such as peroxides, accelerants, and/or inhibitors, can be incorporated into the poly(arylene sulfide).

In an aspect, the poly(arylene sulfide) polymer described herein can further comprise one or more additives. In an embodiment, the poly(arylene sulfide) polymer can ultimately be used or blended in a compounding process, for example, with various additives, such as polymers, fillers, fibers, conventional reinforcing materials, pigments, nucleating agents, antioxidants, ultraviolet (UV) stabilizers (e.g., UV absorbers), lubricants, fire retardants, heat stabilizers, carbon black, plasticizers, corrosion inhibitors, mold release agents, pigments, titanium dioxide, clay, mica, processing aids, adhesives, tackifiers, and the like, or combinations thereof.

In an embodiment, fillers which can be utilized include, but are not limited to, mineral fillers, inorganic fillers, or organic fillers, or mixtures thereof. In some embodiments, the filler can comprise, or consist essentially of, a mineral filler; alternatively, an inorganic filler; or alternatively, an organic filler. In an embodiment, mineral fillers which can be utilized include, but are not limited to, conventional glass fibers, milled fibers, glass beads, asbestos, wollastonite, hydrotalcite, fiberglass, mica, talc, clay, calcium carbonate, magnesium hydroxide, silica, potassium titanate fibers, rockwool, or any combination thereof; alternatively, conventional glass fibers; alternatively, glass beads; alternatively, asbestos; alternatively, wollastonite; alternatively, hydrotalcite; alternatively, fiberglass; alternatively, silica; alternatively, potassium titanate fibers; or alternatively, rockwool. Exemplary inorganic fillers can include, but are not limited to, aluminum flakes, zinc flakes, fibers of metals such as brass, aluminum, zinc, or any combination thereof; alternatively, aluminum flakes; alternatively, zinc flakes; or alternatively, fibers of metals such as brass, aluminum, and zinc. Exemplary organic fillers can include, but are not limited to, carbon fibers, carbon black, graphene, graphite, a fullerene, a buckyball, a carbon nanofiber, a carbon nanotube, or any combination thereof; alternatively, carbon fibers; alternatively, carbon black; alternatively, graphene; alternatively, graphite; alternatively, a fullerene; alternatively, a buckyball; alternatively, a carbon nanofiber; or alternatively, a carbon nanotube. Fibers such as conventional glass fibers, milled fibers, carbon fibers and potassium titanate fibers, and inorganic fillers such as mica, talc, and clay can be incorporated into the composition, which can provide molded articles to provide a composition which can have improved properties.

In an embodiment, pigments which can be utilized include, but are not limited to, titanium dioxide, zinc sulfide, or zinc oxide, and mixtures thereof.

In an embodiment, UV absorbers which can be utilized include, but are not limited to, oxalic acid diamide compounds or sterically hindered amine compounds, and mixtures thereof.

In an embodiment, lubricants which can be utilized include, but are not limited to, polyaphaolefins, polyethylene waxes, polyethylene, high density polyethylene (HDPE), polypropylene waxes, and paraffins, and mixtures thereof.

In an embodiment, the fire retardant can be a phosphorus based fire retardant, a halogen based fire retardant, a boron based fire retardant, an antimony based fire retardant, an amide based fire retardant, or any combination thereof. In an embodiment, phosphorus based fire retardants which can be utilized include, but are not limited to, triphenyl phosphate, tricresyl phosphate, a phosphate obtained from a mixture of isopropylphenol and phenol and phosphorus oxychloride, or phosphate esters obtained from difunctional phenols (e.g., benzohydroquinone or bisphenol A), an alcohol, or a phenol and phosphorus oxychloride; alternatively, triphenyl phosphate; alternatively, tricresyl phosphate; alternatively, a phosphate obtained from a mixture of isopropylphenol and phenol and phosphorus oxychloride; or alternatively, phosphate esters obtained from difunctional phenols (e.g., benzohydroquinone or bisphenol A), an alcohol, or a phenol and phosphorus oxychloride. In an embodiment, halogen based fire retardants which can be utilized include, but are not limited to, brominated compounds. In some embodiments, the halogen based fire retardants which can be utilized include, but are not limited to, decabromobiphenyl, pentabromotoluene, decabromobiphenyl ether, hexabromobenzene, or brominated polystyrene. In an embodiment, stabilizers which can be utilized include, but are not limited to, sterically hindered phenols and phosphite compounds.

In an aspect, the poly(arylene sulfide) described herein can further be processed by melt processing. In an embodiment, melt processing can generally be any process, step(s) which can render the poly(arylene sulfide) in a soft or “moldable state.” In an embodiment, the melt processing can be a step wherein at least part of the polymer composition or mixture subjected to the process is in molten form. In some embodiments, the melt processing can be performed by melting at least part of the polymer composition or mixture. In some embodiments, the melt processing step can be performed with externally applied heat. In other embodiments, the melt processing step itself can generate the heat necessary to melt (or partially melt) the mixture, polymer, or polymer composition. In an embodiment, the melt processing step can be an extrusion process, a melt kneading process, or a molding process. In some embodiments, the melt processing step of any method described herein can be an extrusion process; alternatively, a melt kneading process; or alternatively, a molding process. It should be noted, that when any process described herein employs more than one melt processing step, that each melt process step is independent of each other and thus each melt processing step can use the same or different melt processing method. Other melt processing methods are known to those having ordinary skill in the art can be utilized as the melt processing step.

The poly(arylene sulfide) can be formed or molded into a variety of components or products for a diverse range of applications and industries. For example, the poly(arylene sulfide) can be heated and molded into desired shapes and composites in a variety of processes, equipment, and operations. For example, the poly(arylene sulfide) can be subjected to heat, compounding, injection molding, blow molding, precision molding, film-blowing, extrusion, and so forth. Additionally, additives, such as those mentioned herein, can be blended or compounded within the poly(arylene sulfide) (e.g., PPS). The output of such techniques can include, for example, polymer intermediates or composites including the poly(arylene sulfide) (e.g., PPS), and manufactured product components or pieces formed from the poly(arylene sulfide) (e.g., PPS), and so on. These manufactured components can be sold or delivered directly to a user. On the other hand, the components can be further processed or assembled in end products, for example, in the industrial, consumer, automotive, aerospace, solar panel, and electrical/electronic industries, which can need polymers that have conductivity, high strength, and high modulus, among other properties. Some examples of end products include without limitation synthetic fibers, textiles, filter fabric for coal boilers, papermaking felts, electrical insulation, specialty membranes, gaskets, and packing materials.

In an embodiment, the process for the production of a poly(arylene sulfide) polymer can comprise the step of removing a portion of the first slurry (e.g., evaporating a portion of a liquid phase of a first slurry) to obtain a by-product slurry, wherein the by-product slurry comprises slurry particulates. As will be appreciated by one of skill in the art, and with the help of this disclosure, at least a portion of the slurry particulates present in the by-product slurry have also been present in the first slurry. Further, as will be appreciated by one of skill in the art, and with the help of this disclosure, during the evaporation of a portion of the first slurry to obtain a by-product slurry, some of the particulates present in the first slurry can combine (e.g., aggregate, agglomerate, stick together, etc.) to produce the slurry particulates present in the by-product slurry. Without wishing to be limited by theory, during the evaporation of a portion of the first slurry to obtain a by-product slurry, some compounds that might be at least partially soluble in the first slurry, might not be as soluble in the by-product slurry and might crash out of the solution, due to either a reduction in liquid volume and/or a modification in the composition of a liquid phase of the by-product slurry when compared to a liquid phase of the first slurry. In an embodiment, the slurry particulates of the by-product slurry can comprise an alkali metal halide by-product (e.g., salt, NaCl, etc.), poly(arylene sulfide) polymer impurities (e.g., poly(arylene sulfide) fines, poly(arylene sulfide) oligomers, poly(arylene sulfide) low molecular weight polymers), a molecular weight modifying agent (e.g., an alkali metal carboxylate, sodium acetate), and the like, or combinations thereof. In an embodiment, the by-product slurry can comprise slurry particulates, dissolved salts (e.g., dissolved NaCl, dissolved alkali metal carboxylates, dissolved sodium acetate, etc.), a polar organic compound, water, and the like. As will be appreciated by one of skill in the art, and with the help of this disclosure, the amount and type of liquid present in the by-product slurry influences the solubility of components of the by-product slurry, and some slurry components (e.g., salts, NaCl, alkali metal carboxylates, sodium acetate, etc.) can be partially soluble in the by-product slurry, e.g., a portion of a slurry component can be present in the by-product slurry as a dissolved component (e.g., dissolved salt), while another portion of the same slurry component can be present in the by-product slurry as a solid particulate (e.g., slurry particulate).

In an embodiment, the step of evaporating a portion of the first slurry to obtain a by-product slurry can be accomplished by heating the first slurry, such as for example by external heating; by placing the first slurry in a jacketed container wherein hot water and/or steam can be run through a jacket of such container; by electrical heating; by internal heating; by contacting steam with a portion of the first slurry; and the like; or combinations thereof.

In an embodiment, the step of evaporating a portion of the first slurry to obtain a by-product slurry can yield one or more vapor streams. As will be appreciated by one of skill in the art, and with the help of this disclosure, a vapor stream can condense (i.e., change physical state from gas phase into liquid phase) to form a liquid fraction. In an embodiment, the one or more vapor streams can yield one or more first liquid fractions, wherein the one or more first liquid fractions can comprise water, a halogenated aromatic compound, a polar organic compound, or combinations thereof.

In an embodiment, the first liquid fractions can be further subjected to a step for the recovery of the halogenated aromatic compound and/or polar organic compound (e.g., a distillation step), to yield a recovered halogenated aromatic compound and/or a first recovered polar organic compound (e.g., recovered polar organic compound, recovered NMP, first recovered NMP). In an embodiment, at least a portion of the recovered halogenated aromatic compound and/or the first recovered polar organic compound can be recycled/reused in a subsequent polymerization process for the production of poly(arylene sulfide) (e.g., PPS). In an embodiment, the step of evaporating a portion of the first slurry to obtain a by-product slurry can comprise two or more sub-steps, such as for example a first sub-step wherein an aqueous liquid fraction is recovered, followed by a second sub-step, wherein an organic liquid fraction is recovered.

In an embodiment, at least a portion of the first recovered polar organic compound can be recycled/reused in a step of polymerizing reactants in a reaction vessel to produce a poly(arylene sulfide) reaction mixture and/or a step of processing the poly(arylene sulfide) reaction mixture to obtain a poly(arylene sulfide) polymer and a by-product slurry. In an embodiment, at least a portion of the first recovered polar organic compound can be recycled/reused in a step of washing the poly(arylene sulfide) reaction mixture with a polar organic compound and/or water to obtain a raw poly(arylene sulfide) polymer and a first slurry.

In an embodiment, the slurry particulates of the by-product slurry can be characterized by a slurry particulate size. As used herein, slurry particulate size (e.g., size of a slurry particulate of the by-product slurry) is determined in accordance with the ability of a slurry particulate to pass through a woven wire test sieve as described in ASTM E11-09. For purposes of this disclosure, all references to a woven wire test sieve refer to a woven wire test sieve as described in ASTM E11-09. As used herein, reference to slurry particulate size (e.g., size of a slurry particulate of the by-product slurry) refers to the size of an aperture (e.g., nominal aperture dimension) through which the slurry particulate (e.g., slurry particulate of the by-product slurry) will pass, and for brevity this is referred to herein as “slurry particulate size.” An aperture is an opening in a sieve (e.g., woven wire test sieve) or a screen for particles to pass through. The aperture of the woven wire test sieve is a square and the nominal aperture dimension refers to the width of the square aperture. For purposes of this disclosure, all references to the ability of a slurry particulate (e.g., slurry particulate of the by-product slurry) to pass through a woven wire test sieve refer to the ability of a slurry particulate to pass through a woven wire test sieve as measured in accordance with ASTM D1921-12. As will be appreciated by one of skill in the art, and with the help of this disclosure, the slurry particulate size is determined by wet testing, e.g., the ability of a slurry particulate to pass through a woven wire test sieve is measured by passing an amount of a slurry containing the slurry particulates through a woven wire test sieve. For example, a slurry particulate (e.g., slurry particulate of the by-product slurry) is considered to have a size of less than about 152 microns if the slurry particulate passes through the aperture of a 100 mesh woven wire test sieve, where the mesh size is given based on U.S. Sieve Series. As will be appreciated by one of skill in the art, and with the help of this disclosure, slurry particulates (e.g., slurry particulates of the by-product slurry) can have a plurality of shapes, such as for example cylindrical, discoidal, spherical, tabular, ellipsoidal, equant, irregular, or combinations thereof. Generally, for a slurry particulate to pass through an aperture of a sieve or screen, it is not necessary for all dimensions of the particle to be smaller than the aperture of such screen or sieve, and it could be enough for one of the dimensions of the slurry particulate to be smaller than the aperture of such screen or sieve. For example, if a cylindrical shaped slurry particulate that has a diameter of 100 microns and a length of 300 microns passes through the aperture of a 100 mesh woven wire test sieve, where the mesh size is according to U.S. Sieve Series, such slurry particulate is considered to have a slurry particulate size of less than about 152 microns. In an alternative embodiment, particle size analyzers, such as for example standard particle size analyzers, light scattering analyzers, etc., could also be used to determine slurry particulate size.

In an embodiment, the slurry particulates can be characterized by the slurry particulate size of less than about 178 microns, alternatively less about 152, or alternatively less about 125 microns. In an embodiment, the slurry particulates can pass through a 150 mesh sieve or screen, alternatively through a 100 mesh sieve, or alternatively through a 50 mesh sieve.

In an embodiment, a process for the production of a poly(arylene sulfide) polymer can comprise the step of removing (e.g., evaporating) at least a portion of the by-product slurry to yield salt solids particulates, wherein at least a portion of the removing (e.g., evaporating) is carried out while simultaneously sizing the salt solids particulates to a desired size. In an embodiment, the step of removing (e.g., evaporating) at least a portion of the by-product slurry to yield salt solids particulates comprises removing (e.g., evaporating) at least a portion of the polar organic compound and/or water from the by-product slurry to yield salt solids particulates, wherein at least a portion of the removing (e.g., evaporating) at least a portion of the polar organic compound and/or water is carried out while simultaneously sizing the salt solids particulates to a desired size.

In an embodiment, the step of evaporating at least a portion of the by-product slurry to yield salt solids particulates comprises introducing the by-product slurry to a sizing dryer, wherein at least a portion of liquid (e.g., a polar organic compound and/or water) in the by-product slurry is evaporated and the desired size of the salt solids particulates can be provided by the sizing dryer. In an embodiment, the desired size of the salt solids particulates can be achieved by sizing the salt solids particulates.

In an embodiment, sizing the salt solids particulates comprises mechanically reducing a size of the particulates and/or preventing agglomeration of the particulates, such as for example by chopping, grinding, or the like, or combinations thereof. In an embodiment, the sizing dryer comprises a chopping dryer (e.g., a dryer that mechanically reduces the size of particulates and/or prevents the agglomeration of particulates by chopping with one or more choppers or chopping devices). While the present disclosure will be discussed in detail in the context of a chopping dryer (e.g., a dryer that mechanically reduces the size of particulates and/or prevents the agglomeration of particulates by chopping), it should be understood that any other suitable dryer configurations could be used, wherein the dryer employs a means for mechanically reducing the size of particulates and/or a means for preventing the agglomeration of particulates, such as for example a grinding dryer (e.g., a dryer that mechanically reduces the size of particulates and/or prevents the agglomeration of particulates by grinding with one or more grinders or grinding devices), etc.

In an embodiment, mechanically reducing a size of the salt solids particulates and/or preventing agglomeration of the salt solids particulates can rely on impact, compression, shear, or combinations thereof. For example, grinding relies on impact, either impacting a particulate with an outside force, or impacting (e.g., accelerating) a particulate against another particulate or a component or surface within the device; compression involves size reduction caused predominantly by pressure, but also by friction from the surfaces of the neighboring particulates; shearing, or stressing by cutting, generally makes use of rotary knife cutters that cut materials on shearing edges.

In an embodiment, mechanically reducing a size of the salt solids particulates and/or preventing agglomeration of the salt solids particulates can involve the use of dryers comprising choppers, chopping devices (e.g., a chopping dryer), grinders (e.g., a grinding dryer), mills, ball mills, impact mills, long-gap mills, fluid energy impact mills, spiral jet mills, fluidized-bed jet mills, cutting mills, crushers, granulators, hammer mills, vibrating screen hammer mills, cryogenic impact mills, screen mills, universal mills, fine-grinding impact mills, pin mills, mills with classifiers, air-classifier mills, roller mills, disc mills, attrition mills, air swept pulverizers, or combinations thereof.

In an embodiment, the sizing dryer comprises a mechanically fluidized bed mixing device, such as for example a plow mixer. In an embodiment, the sizing dryer can comprise a plurality of mixing tools, wherein the mixing tools can create a mechanically fluidized bed mixing action, wherein a material (e.g., by-product slurry, slurry particulates, salt solids particulates, etc.) inside the sizing dryer is in a continuous three-dimensional motion throughout all or a portion of a body of the sizing dryer. In such embodiment, the mixing tools can provide a homogeneous mixing action of the material (e.g., by-product slurry, slurry particulates, salt solids particulates, etc.) across substantially an entire length of the sizing dryer. In an embodiment, the mixing tools can assist in moving the material (e.g., by-product slurry, slurry particulates, salt solids particulates, etc.) from one end (e.g., a receiving end) towards another end (e.g., a delivering end) of the sizing dryer.

In an embodiment, the mixing tools comprise shear tools, blades, sharpened blades, plow or plough blades, sharpened plow blades, paddles, sharpened paddles, choppers, augers, screws, and the like, or combinations thereof.

In an embodiment, movement (e.g., rotation) of the mixing tools can create a plurality of low shear zones within the sizing dryer, thereby mechanically reducing a size of salt solids particulates and/or preventing agglomeration of salt solids particulates. In an embodiment, rotation of the mixing tools can create one or more low shear zones within the sizing dryer, thereby mechanically reducing a size of salt solids particulates and/or preventing agglomeration of salt solids particulates. As will be appreciated by one of skill in the art, and with the help of this disclosure, if one mixing tool is used, one low shear zone is created, if three mixing tools are used, three low shear zones are created, etc. In an embodiment, the mixing tools prevent agglomeration of the salt solids particulates by mixing the salt solids particulates and by cutting into forming agglomerations of salt solids particulates. As will be appreciated by one of skill in the art, and with the help of this disclosure, the configuration of the mixing tools (e.g., size of mixing tools, number of mixing tools, shape of mixing tools, spatial arrangement of mixing tools, etc.) can be adjusted to achieve a desired level of shear within the low shear zone.

In an embodiment, the mixing tools can be configured to project and hurl material (e.g., by-product slurry, slurry particulates, salt solids particulates, etc.) away from a wall of the sizing dryer (e.g., a body of the sizing dryer) into free space in a crisscross direction, and inversely back again. In an embodiment, the mixing tools can be configured to separate and lift the material (e.g., by-product slurry, slurry particulates, salt solids particulates, etc.) into a three-dimensional motion, while number and arrangement of the mixing tools can insure agitation back and forth along a length of the sizing dryer body.

In an embodiment, the sizing dryer can further comprise one or more high shear tools. In an embodiment, the high shear tool comprises a chopper device, a high shear chopper device, a high velocity chopper device, an impeller, a high shear impeller, a high velocity impeller, a propeller, a high shear propeller, a high velocity propeller, a propeller with sharpened blades, and the like, or combinations thereof. In an embodiment, the high shear tool can further comprise a high-speed power device, wherein the high-speed power device can impart a fast rotating motion to the high shear tool. As will be appreciated by one of skill in the art, and with the help of this disclosure, a rotating motion of the high shear tool is faster than a rotating motion of the mixing tools.

In an embodiment, movement (e.g., rotation) of the high shear tools can create one or more high shear zones within the sizing dryer, thereby mechanically reducing the size of salt solids particulates and/or preventing agglomeration of salt solids particulates. As will be appreciated by one of skill in the art, and with the help of this disclosure, if one high shear tool is used, one high shear zone is created, if five high shear tools are used, five high shear zones are created, etc.

In some embodiments, the high shear tools can operate continuously throughout the operation of the sizing dryer. In such embodiments, the high shear tools can prevent the agglomeration of the salt solids particulates by mixing the salt solids particulates at high velocities and by cutting into at least a portion of forming and/or formed agglomerations of salt solids particulates.

In other embodiments, the high shear tools can operate intermittently. In such embodiments, the high shear tools can be operated (e.g., turned on, activated, powered, etc.) when a load is noticed on a shaft that supports the mixing tools (e.g., a mixing shaft), e.g., when the rotational motion of the shaft slows down while other operational parameters of the sizing dryer (e.g., loading of the sizing dryer, temperature of the sizing dryer, etc.) are maintained at about the same level. In such embodiments, the high shear tools do not prevent the agglomeration of the salt solids particulates, but rather the high shear tools cut into and break apart agglomerations of salt solids particles.

In an embodiment, combinations of low and high shear mixing zones and associated devices can be combined within a single vessel to obtain a suitable mixing/shearing profile along the length of the vessel to prevent and/or reduce the size of agglomerations of salt solids particles. Further such combinations of low and high shear mixing zones and associated devices can be controlled to further provide a desired mixing/shearing profile along the length of the vessel to prevent and/or reduce the size of agglomerations of salt solids particles. For example, one or more low shear zones or devices can be continuously operated and one or more high shear zones can be intermittently operated, for example via a timer, designated on/off sequence or program, in response to an operational condition indicated a need for increased shear, or combinations thereof). Combinations of low and high shear mixing zones and associated devices can overlap within a given vessel.

In an embodiment, the sizing dryer can be heated to promote evaporation and recovery of a polar organic compound, e.g., a recovered polar organic compound (e.g., recovered NMP), a second recovered polar organic compound (e.g., a second recovered NMP). In an embodiment, at least a portion of the second recovered polar organic compound can be recycled/reused in a subsequent polymerization process for the production of poly(arylene sulfide) (e.g., PPS).

In an embodiment, at least a portion of the second recovered polar organic compound can be recycled/reused in a step of polymerizing reactants in a reaction vessel to produce a poly(arylene sulfide) reaction mixture and/or a step of processing the poly(arylene sulfide) reaction mixture to obtain a poly(arylene sulfide) polymer and a by-product slurry. In an embodiment, at least a portion of the second recovered polar organic compound can be recycled/reused in a step of washing the poly(arylene sulfide) reaction mixture with a polar organic compound and/or water to obtain a raw poly(arylene sulfide) polymer and a first slurry.

In an embodiment, the sizing dryer can be heated by external heating, jacket heating, internal heating, introducing steam to the sizing dryer, heating internal elements of the sizing dryer, wherein the internal elements can comprise a shaft (e.g., a mixing shaft) and/or a mixing tool, and the like, or combinations thereof.

In some embodiments, the sizing dryer can be operated in a continuous flow mode (as opposed to a batch mode), wherein the by-product slurry is continuously introduced to the sizing dryer, while a second recovered polar organic compound and salt solids particulates are continuously recovered. In other embodiments, the sizing dryer can be operated in a batch mode (as opposed to a continuous flow mode), wherein a predetermined quantity of the by-product slurry is introduced to the sizing dryer, followed by recovery of at least a portion of the polar organic compound and the salt solid particulates. In some other embodiments, the sizing dryer can be operated in a semi-batch mode, wherein a predetermined quantity of the by-product slurry is introduced to the sizing dryer, and at least a part of the recovery of at least a portion of the polar organic compound and the salt solid particulates occurs at the same time as the introduction of the by-product slurry to the sizing dryer. In yet other embodiments, the sizing dryer can be operated in a pulse continuous fashion, wherein contents of the sizing dryer can be partially dumped (e.g., removed from the sizing dryer) followed by introducing more by-product slurry to the sizing dryer, in a pulse manner, and wherein a time between pulses allows for removal of enough polar organic compound to achieve a desirable dryness level of the solid salt particulates.

In an embodiment, the sizing dryer can be used in conjunction with any other dryer, evaporator, and/or mixer as it is suitable for the recovery of the second recovered polar organic compound from the by-product slurry and for obtaining salt solids particulates. In some embodiments, two or more sizing dryers can be used in parallel with each other. In other embodiments, two or more sizing dryers can be used in series with each other. In some other embodiments, sizing dryers can be used in any combination of series and/or parallel configurations necessary to achieve a desired level of recovery of the second recovered polar organic compound and/or salt solids particulates.

In some embodiments, a process for the production of a poly(arylene sulfide) polymer can comprise the use of a sizing dryer upstream of a conventional dryer, wherein the conventional dryer can be used for further drying the salt solids particulates. As will be appreciated by one of skill in the art, and with the help of this disclosure, a conventional dryer can be generally used for evaporating at least a portion of the polar organic compound from a slurry (e.g., a by-product slurry) to yield particulates (e.g., salt solids particulates) and/or for evaporating at least a portion of the polar organic compound from particulates (e.g., salt solids particulates) to achieve a desired level of dryness of the particulates; however, the conventional dryer does not size particulates, e.g., does not prevent formation of large agglomerations of particles (e.g., particulate agglomerations, salt aggregates, etc.). In other embodiments, a process for the production of a poly(arylene sulfide) polymer can comprise the use of a sizing dryer in place of a conventional dryer for evaporating at least a portion of the polar organic compound from the by-product slurry to yield salt solids particulates.

In an embodiment, the sizing dryer comprises a chopping dryer. In an embodiment, the chopping dryer comprises a mechanically fluidized bed mixing device, such as for example a plow mixer. In an embodiment, the by-product slurry can be introduced (e.g., fed) to a chopping dryer, to yield salt solids particulates and a second recovered polar organic compound.

In an embodiment, the chopping dryer comprises a receiving end, a delivering end, and an elongated mixing chamber, wherein the elongated mixing chamber is disposed between the receiving end and the delivering end. In an embodiment, the receiving end can comprise a by-product slurry port, wherein the by-product slurry can be introduced to the chopping dryer through a by-product slurry port. In an embodiment, the by-product slurry port can be located (e.g., positioned, situated, placed, etc.) on a side of the chopping dryer (e.g., on a receiving end of the chopping dryer).

In an embodiment, the chopping dryer can have a horizontal configuration, wherein the elongated mixing chamber can be disposed generally horizontally with respect to a ground surface on which it rests, and wherein the receiving end comprises the by-product slurry port.

In an alternative embodiment, the elongated mixing chamber of the chopping dryer is sloped with respect to a ground surface on which it rests. In some embodiments, the side of the chopping dryer comprising the receiving end is elevated when compared to the side of the chopping dryer comprising the delivering end. In such embodiment, the side of the chopping dryer comprising the receiving end is elevated at an angle equal to or greater than about 5, 10, 15, 20, 25, 30, 35, 40, or 45 degrees when compared to the side of the chopping dryer comprising the delivering end, with respect to a ground surface on which it rests. As will be appreciated by one of skill in the art, and with the help of this disclosure, the same chopping dryer with a horizontal configuration can be converted into a chopping dryer with a sloped configuration by elevating one end (e.g., the receiving end) of the chopping dryer.

In other embodiments, the side of the chopping dryer comprising the receiving end is lowered when compared to the side of the chopping dryer comprising the delivering end. In such embodiment, the side of the chopping dryer comprising the receiving end is lowered at an angle equal to or greater than about 5, 10, 15, 20, 25, 30, 35, 40, or 45 degrees when compared to the side of the chopping dryer comprising the delivering end, with respect to a ground surface on which it rests.

In an embodiment, the delivering end of the chopping dryer comprises a salt solids particulates outlet. In some embodiments, the salt solids particulates outlet can be located on a side of the chopping dryer (e.g., on a delivering end of the chopping dryer), wherein the salt solids particulates outlet is adjacent to a bottom side of the chopping dryer, e.g., the salt solids particulates outlet is located within a lower half of the chopping dryer, e.g., within a lower half of the delivering end. In an embodiment, the salt solid particulates can be recovered (e.g., exit the chopping dryer) through the salt solids particulates outlet. In an embodiment, materials (e.g., by-product slurry, slurry particulates, salt solids particulates, etc.) inside the chopping dryer move from the receiving end towards the delivering end, wherein the salt solid particulates can be recovered through the salt solids particulates outlet. In an embodiment, the salt solids particulates outlet can have a circular cross section, wherein the circular cross section of the salt solids particulates outlet can be characterized by a diameter of the circular cross section of the salt solids particulates outlet. In an embodiment, the diameter of the circular cross section of the salt solids particulates outlet can have a value of from about 100 cm to about 1 cm, alternatively from about 50 cm to about 2.5 cm, or alternatively from about 40 cm to about 10 cm. As will be appreciated by one of skill in the art and with the help of this disclosure, the size of the salt solids particulates outlet can be any suitable size that would allow the salt solids particulates to flow outside the chopping dryer. For example, the salt solids particulates outlet could be as big as the body of the chopping dryer. Further, for example, the salt solids particulates outlet could be as small as would allow the salt solids particulates to flow outside the chopping dryer. As will be appreciated by one of skill in the art and with the help of this disclosure, the size of the salt solids particulates outlet can be just large enough to allow the salt solids particulates to flow out. For example, the size of the salt solids particulates outlet could be roughly greater than about 3 times the salt solids particulate size.

In an embodiment, the chopping dryer can be heated to promote evaporation and recovery of the second recovered polar organic compound. In an embodiment, the chopping dryer can be heated by using external heating, jacket heating, internal heating, introducing steam to the chopping dryer, heating internal elements of the chopping dryer (e.g., a shaft, a mixing shaft, a mixing tool, etc.), and the like, or combinations thereof.

In an embodiment, internal heating comprises further introducing steam to the chopping dryer. In such embodiment, the steam can be introduced to the chopping dryer through a steam port. In an embodiment, the steam port can be located on a side of the chopping dryer. In an embodiment, the receiving end of the chopping dryer comprises the steam port.

In an embodiment, the steam port and the by-product slurry port can be positioned adjacent to each other, e.g., in close spatial proximity to each other. In some embodiments, the steam port and the by-product slurry port can be positioned in a concentric position with respect to each other. As will be appreciated by one of skill in the art, and with the help of this disclosure, one of the ports can be positioned in the middle of another annular port, wherein the cross section of the ports can have any suitable geometry, circular, elliptical, square, rectangular, etc. In an embodiment, the by-product slurry port is a circular port surrounded by an annular circular steam port. In an alternative embodiment, the steam port is a circular port surrounded by an annular circular by-product slurry port. In an embodiment, the steam port can comprise any suitable configuration that allows for an effective heat transfer between the steam and the by-product slurry, thereby enabling the recovery of at least a portion of the polar organic compound of the by-product slurry (e.g., recovered second polar organic compound).

In an embodiment, at least a portion of the polar organic compound of the by-product slurry can be recovered as recovered polar organic compound through a polar organic compound outlet. In some embodiments, the polar organic compound outlet can be located on a top side of the chopping dryer. In other embodiments, the polar organic compound outlet can be located on a side of the chopping dryer, wherein the polar organic compound outlet is adjacent to a top side of the chopping dryer, e.g., the polar organic compound outlet is located within an upper half of the chopping dryer. As will be appreciated by one of skill in the art, and with the help of this disclosure, the polar organic compound is recovered through the polar organic compound outlet as polar organic compound vapors. Further, as will be appreciated by one of skill in the art, and with the help of this disclosure, when steam is introduced to the chopping dryer along with the by-product slurry, water vapors of the steam can also be recovered along with the polar organic compound through a polar organic compound outlet. In an embodiment, the second recovered polar organic compound can comprise water in an amount of less than about 80 wt. %, alternatively less than about 50 wt. %, or alternatively less than about 30 wt. %, based on the total weight of the second recovered polar organic compound. In an embodiment, the polar organic compound vapors can further condense to yield a polar organic compound liquid fraction (e.g., a second recovered polar organic compound).

In an embodiment, the second recovered polar organic compound can be further processed (e.g., dehydrated, purified, etc.) and/or recycled/reused in a subsequent polymerization process for the production of poly(arylene sulfide) (e.g., PPS). In an embodiment, the second recovered polar organic compound can be further subjected to a dehydration process (e.g., water removal process) and/or to a purification process (e.g., distillation) prior to being recycled/reused in a subsequent polymerization process for the production of poly(arylene sulfide) (e.g., PPS).

In an embodiment, the chopping dryer can comprise a mixing shaft and a plurality of mixing tools, wherein the mixing tools are attached to the mixing shaft, and wherein the mixing shaft can rotate within the chopping dryer, thereby causing the mixing tools to rotate. In an embodiment, the rotation of the mixing tools can create one or more low shear zones within the chopping dryer, thereby mechanically reducing the size of particulates (e.g., salt solids particulates) and/or preventing agglomeration of particulates (e.g., salt solids particulates), as previously described herein. In an embodiment, the mixing shaft can be characterized with respect to a central or longitudinal shaft axis. In an embodiment, the mixing shaft can comprise a rod, a hollow pipe, or combinations thereof. In an embodiment, the chopping dryer can be characterized with respect to a central or longitudinal dryer axis, wherein the chopping dryer generally comprises a cylindrical or tubular structure or body (e.g., an elongated mixing chamber). The chopping dryer body (e.g., an elongated mixing chamber) can be coaxially aligned with the mixing shaft, e.g., the longitudinal shaft axis can coincide with the longitudinal dryer axis.

In an embodiment, internal heating of the chopping dryer can further comprise heating internal elements of the chopping dryer, wherein the internal elements can comprise the shaft (e.g., mixing shaft) and/or the mixing tools. In such embodiment, heat from the shaft and/or the mixing tools can be transferred to the by-product slurry, thereby assisting in evaporating at least a portion of the polar organic compound from the by-product slurry.

In some embodiments, the mixing shaft can extend across an entire length of the chopping dryer, e.g., across an entire length from the receiving end to the delivering of the chopping dryer. In other embodiments, the mixing shaft can extend across a partial length of the chopping dryer, e.g., across a partial length of the chopping dryer. In an embodiment, the mixing shaft can be connected to a powering device, wherein the powering device can impart a rotating motion to the mixing shaft, thereby causing the mixing tools to rotate inside the chopping dryer (e.g., inside the mixing chamber of the chopping dryer) and create one or more low shear zones within the chopping dryer. In an embodiment, the motion (e.g., rotation) of the mixing tools can be modulated (e.g., modified, controlled, varied, adjusted), e.g., the intensity of the motion (e.g., rotation) of the mixing tools can be adjusted, thereby adjusting the amount of shear that the mixing tools impart within the one or more low shear zones within the chopping dryer.

In an embodiment, the mixing tools are affixed (e.g., attached, fixed, coupled, etc.) onto the mixing shaft such that when the mixing shaft rotates, the mixing tools rotate with the shaft. In an embodiment, the mixing tools extend radially from the mixing shaft towards the body of the chopping dryer, e.g., the mixing tools depend generally perpendicularly from the mixing shaft. In an embodiment, the mixing tool is connected to the mixing shaft in a connecting point.

In an embodiment, the chopping dryer further comprises one or more high shear tools. In an embodiment, motion (e.g., rotation) of the high shear tools can create one or more high shear zones within the chopping dryer, thereby mechanically reducing the size of particulates (e.g., salt solids particulates) and/or preventing agglomeration of particulates (e.g., salt solids particulates), as previously described herein. In an embodiment, the motion (e.g., rotation) of the high shear tools can be modulated, e.g., the intensity of the motion (e.g., rotation) of the high shear tools can be adjusted, thereby adjusting the amount of shear that the high shear tools impart within the one or more high shear zones within the chopping dryer.

In an embodiment, the motion of the mixing tools and the motion of the high shear tools can be modulated independently from each other. For example, the motion of the mixing tools can be kept constant, while the motion of the high shear tools can be modulated. As another example, the motion of the mixing tools can be modulated, while the motion of the high shear tools can be kept constant. Further, for example, the motion of both the mixing tools and the high shear tools can be modulated. Further, as another example, the motion of both the mixing tools and the high shear tools can be kept constant. As will be appreciated by one of skill in the art, and with the help of this disclosure, the high shear tools can be powered on (e.g., switched on, turned on, activated, set in motion, etc.) independently of the mixing tools.

In an embodiment, the chopping dryer can further comprise one or more high shear ports across the length of the body of the chopping dryer (e.g., elongated mixing chamber). In an embodiment, the high shear ports are located in the lower half of the chopping dryer. In an embodiment, the high shear ports can be aligned to match about a half point in a distance between two connecting points (e.g., points where the mixing tools connect to the mixing shaft) on the mixing shaft.

In an embodiment, a high shear tool can be inserted into the chopping dryer through the high shear port. In an embodiment, the high shear tool can be characterized with respect to a central or longitudinal high shear axis. In an embodiment, the longitudinal high shear axis is perpendicular to the longitudinal shaft axis. As will be appreciated by one of skill in the art, and with the help of this disclosure, the chopping dryer can comprise one, two, three, four, five, six, seven, eight, nine, ten, or more high shear ports. Further, as will be appreciated by one of skill in the art, and with the help of this disclosure, all high shear ports can be located on one side of the chopping dryer, or the high shear ports can be located on both sides of the chopping dryer. Also, as will be appreciated by one of skill in the art, and with the help of this disclosure, some shear ports can be closed (e.g., unused, temporarily obstructed, etc.), while some other high shear ports can house the high shear tools. For example, if a chopping dryer comprises eight high shear ports, three high shear ports could house high shear tools (e.g., a total of three high shear tools) and the other five high shear ports could be closed.

In an embodiment, the high shear tool can extend radially towards the mixing shaft, across a length of the radius of the body of the chopping dryer (e.g., elongated mixing chamber). In an embodiment, the high shear tool is spatially located between two adjacent mixing tools, wherein the high shear tool does not touch either the mixing tools or the mixing shaft.

In an embodiment, the chopping dryer comprises a commercially available plow mixer, such as for example Littleford PLOUGHSHARE continuous mixers (KM Series) and/or Littleford PLOUGHSHARE batch mixers (FKM Series), both of which are available from Littleford Day. Littleford PLOUGHSHARE continuous mixers (KM Series) and/or Littleford PLOUGHSHARE batch mixers (FKM Series) are available in standard production sizes ranging from 11 cu. ft./300 liters to 883 cu. ft./25,000 liters, total capacity. However, these mixers are also available in laboratory sizes for process development and formula optimization. In an embodiment, the chopping dryer comprises Littleford PLOUGHSHARE continuous mixer model number KM-20000-D and/or Littleford PLOUGHSHARE batch mixer model number FKM-20000-D.

In an embodiment, the salt slurry particulates can be recovered from the sizing dryer, e.g., from the chopping dryer through the salt solids particulates outlet. In an embodiment, the salt solids particulates can originate (e.g., come, arise, etc.) from the by-product slurry, and can comprise slurry particulates, combined (e.g., aggregated, agglomerated, stuck together, joined together, etc.) slurry particulates, particulates that crash out of the solution as the amount of the liquid phase of the slurry diminishes due to the evaporation and/or recovery of polar organic compound, wherein the particulates that crash out of the solution can originate in the dissolved salts of the by-product slurry (e.g., dissolved NaCl, dissolved alkali metal carboxylates, dissolved sodium acetate, etc.).

As will be appreciated by one of skill in the art, and with the help of this disclosure, some slurry particulates will aggregate, thereby forming some of the salt solids particulates that have a size larger than any of the slurry particulates that have entered the sizing dryer as part of the by-product slurry. However, the sizing dryer can prevent the slurry particulates from agglomerating (e.g., size the particulates) to an extent where the salt solids particulates can not exit the sizing dryer through the salt solids particulates outlet. For purposes of the disclosure herein, particulate agglomerations are basically salt solids particulates that have grown (e.g., aggregated) to a size larger than a desired size for the salt solids particulates, e.g., a size of the salt solids particulates that allows the salt solids particulates to exit the sizing dryer through a salt solids particulates outlet. For purposes of the disclosure herein, “agglomerating” refers to the process through which the particulates in a slurry (e.g., a by-product slurry) grow to undesirably large sizes, such as for example to yield particulate agglomerations.

In an embodiment, evaporating at least a portion of the polar organic compound from the by-product slurry can cause the slurry particulates and/or salt solids particulates (e.g., forming and/or already formed salt solids particulates) to combine (e.g., become more intimately contacted and bound in some fashion), thereby forming salt solids particulates (e.g., particulates, particulate agglomerations, etc.). Without wishing to be limited by theory, particulate agglomerations can occur/form when a salt (e.g., alkali metal halide by-product, NaCl, alkali metal carboxylates, sodium acetate, etc.) crystallizes due to evaporation/removal of at least a portion of a liquid phase of the by-product slurry, wherein the poly(arylene sulfide) polymer impurities (e.g., poly(arylene sulfide) oligomers and/or poly(arylene sulfide) low molecular weight polymers) stick to salt crystals, thereby binding or gluing the salt crystals together, to yield particulate agglomerations.

In an embodiment, the salt solids particulates can comprise an alkali metal halide by-product (e.g., salt, NaCl, etc.) and/or poly(arylene sulfide) polymer impurities (e.g., poly(arylene sulfide) fines, poly(arylene sulfide) oligomers, poly(arylene sulfide) low molecular weight polymers). In an embodiment, the salt solids particulates can further comprise a molecular weight modifying agent (e.g., an alkali metal carboxylate, sodium acetate). As will be appreciated by one of skill in the art, and with the help of this disclosure, other impurities, such as for example traces of reagents, by-products of the polymerization reaction, and the like, can also be present in the salt solids particulates.

In an embodiment, the salt solids particulates can comprise an alkali metal halide by-product (e.g., salt, NaCl, etc.) in an amount of from about 50 wt. % to about 99 wt. %, alternatively, from about 75 wt. % to about 95 wt. %, or alternatively, from about 80 wt. % to about 90 wt. %, based on the total weight of the salt solids particulates. In an embodiment, the alkali metal halide by-product (e.g., salt, NaCl, etc.) can comprise the balance of the salt solids particulates after considering the amount of the other components.

In an embodiment, the salt solids particulates can comprise polymer impurities (e.g., poly(arylene sulfide) oligomers and/or poly(arylene sulfide) low molecular weight polymers) in an amount of from about 1 wt. % to about 30 wt. %, alternatively, from about 5 wt. % to about 25 wt. %, or alternatively, from about 10 wt. % to about 20 wt. %, based on the total weight of the salt solids particulates.

In an embodiment, the salt solids particulates can further comprise a polar organic compound, e.g., a polar organic compound that was not removed in the sizing dryer. In an embodiment, the salt solids particulates can comprise a polar organic compound in an amount of from equal to or less than about 5 wt. %, alternatively less than about 1 wt. %, alternatively less than about 0.5 wt. %, alternatively less than about 0.1 wt. %, alternatively less than about 0.01 wt. %, alternatively less than about 0.001 wt. %, alternatively less than about 0.0001 wt. %, or alternatively about 0 wt. %, based on the total weight of the salt solids particulates.

In an embodiment, the salt solid particulates can be characterized by a salt solids particulate size (e.g., a desired size for the salt solids particulates). As used herein, reference to salt solids particulate size (e.g., size of a salt solids particulate obtained by evaporating at least a portion of the polar organic compound from the by-product slurry) refers to the size of an aperture (e.g., salt solids particulates outlet) through which the salt solids particulate (e.g., a salt solids particulate obtained by evaporating at least a portion of the polar organic compound from the by-product slurry) will pass, and for brevity this is referred to herein as “salt solids particulate size.” As will be appreciated by one of skill in the art, and with the help of this disclosure, salt solid particulates can have a plurality of shapes, such as for example cylindrical, discoidal, spherical, tabular, ellipsoidal, equant, irregular, or combinations thereof. Generally, for a salt solids particulate to pass through an aperture (e.g., salt solids particulates outlet), it is not necessary for all dimensions of the particulate to be smaller than the aperture, and it could be enough for one of the dimensions of the salt solids particulate to be smaller than the aperture. In an embodiment, the salt solids particulate size can be determined by measurements similar to standard particulate (e.g., particle) size measurements, such as physically sifting the material (e.g., sifting through a woven wire test sieve) through a sieve or test sieve; and/or by standard particulate (e.g., particle) size measurements, such as physically sifting (e.g., wet sifting) the material (e.g., sifting through a woven wire test sieve) in accordance with ASTM D1921-12. As will be appreciated by one of skill in the art, and with the help of this disclosure, the size of the salt solids particulate can be fairly large, wherein the salt solids particulates can be too large to pass through any sizes of test sieves available as part of the U.S. Sieve Series. Further, as will be appreciated by one of skill in the art, and with the help of this disclosure, test sieves can be designed for testing such materials, wherein the test sieves are assembled according to the standards of the U.S. Sieve Series, however, with apertures large enough to allow the material to be tested to pass through such apertures. For purposes of the disclosure herein, the aperture of a test sieve is a square and the aperture dimension refers to the width of the square aperture, whether the sieve is a woven wire test sieve or a test sieve that was assembled specifically for measuring the size of the salt solids particulates. For example, if a salt solids particulate comprises a cylinder with a height of 55 mm and a diameter of 23 mm, and the test sieve aperture has a size of 25 mm, then the salt solids particulate can pass through the aperture of the test sieve and it is considered that the salt solids particulate size is less than about 25 mm.

In an embodiment, the salt slurry particulates can be characterized by a size (e.g., a desired size) of less than about 150 mm, alternatively less than about 100 mm, or alternatively, less than about 50 mm, alternatively, less than about 25 mm, alternatively less than about 10 mm, alternatively less than about 9 mm, alternatively less than about 8 mm, alternatively less than about 7 mm, alternatively less than about 6 mm, alternatively less than about 5 mm, alternatively less than about 4 mm, alternatively less than about 3 mm, alternatively less than about 2 mm, alternatively less than about 1 mm, alternatively less than about 0.5 mm, alternatively less than about 0.1 mm, alternatively less than about 0.05 mm, or alternatively less than about 0.03 mm.

In an embodiment, a ratio of a size of the salt solids particulates to the diameter of the salt solids particulates outlet (e.g., the diameter of the circular cross section of the salt solids particulates outlet) is less than about 0.9, alternatively, less than about 0.75, alternatively, less than about 0.5, alternatively, less than about 0.25, or alternatively, less than about 0.1.

In an embodiment, a ratio of a size of the salt solids particulates to a size of the slurry particulates is less than about 10, alternatively, less than about 5, alternatively, less than about 3, alternatively, less than about 1, or alternatively, less than about 0.5.

In an embodiment, the salt solids particulates recovered from the sizing dryer (e.g., chopping dryer) can be further solubilized in water and/or an aqueous solution, to yield a salt solution. In such embodiment, the alkali metal halide by-product (e.g., salt, NaCl, etc.), as well as any other salts that might be present in the salt solids particulates (e.g., a molecular weight modifying agent, an alkali metal carboxylate, sodium acetate, etc.) can be solubilized in the water and/or an aqueous solution, to yield the salt solution, while the poly(arylene sulfide) polymer impurities (e.g., poly(arylene sulfide) fines, poly(arylene sulfide) oligomers, poly(arylene sulfide) low molecular weight polymers) will remain as a solid phase in the salt solution. In an embodiment, the salt solution can be further filtered to remove the poly(arylene sulfide) polymer impurities (e.g., poly(arylene sulfide) oligomers and/or poly(arylene sulfide) low molecular weight polymers). In an embodiment, the poly(arylene sulfide) polymer impurities (e.g., poly(arylene sulfide) oligomers and/or poly(arylene sulfide) low molecular weight polymers) can be discarded or disposed of. In an embodiment, the salt solution can be discarded or disposed of. In an alternative embodiment, the salt solution can be recycled.

In an embodiment, a process for producing a poly(phenylene sulfide) polymer can comprise (a) polymerizing reactants in a reaction vessel to produce a poly(phenylene sulfide) reaction mixture; (b) processing the poly(phenylene sulfide) reaction mixture to obtain a poly(phenylene sulfide) polymer and a by-product slurry; and (c) evaporating at least a portion of the by-product slurry to yield salt solids particulates, wherein at least a portion of the evaporating can be carried out while simultaneously sizing the salt solids particulates to a desired size, and wherein the salt solids particulates comprise equal to or less than about 5 wt. % N-methyl-2-pyrrolidone.

In an embodiment, a process for producing a poly(phenylene sulfide) polymer can comprise (a) reacting a sulfur source and a dihaloaromatic compound in the presence of N-methyl-2-pyrrolidone to form a poly(phenylene sulfide) reaction mixture; (b) washing the poly(phenylene sulfide) reaction mixture with N-methyl-2-pyrrolidone and/or water to obtain a washed poly(phenylene sulfide) polymer and by-product slurry; and (c) evaporating at least a portion of the by-product slurry to yield salt solids particulates, wherein at least a portion of the evaporating can be carried out while simultaneously sizing the salt solids particulates to a desired size, and wherein the salt solids particulates comprise equal to or less than about 5 wt. % N-methyl-2-pyrrolidone.

In an embodiment, a process for producing a poly(phenylene sulfide) polymer can comprise (i) reacting a sulfur source and a dihaloaromatic compound in the presence of N-methyl-2-pyrrolidone to form a poly(phenylene sulfide) reaction mixture; (ii) washing the poly(phenylene sulfide) reaction mixture with N-methyl-2-pyrrolidone and/or water to obtain a raw poly(phenylene sulfide) polymer and a first slurry; (iii) treating at least a portion of the raw poly(phenylene sulfide) polymer with an aqueous acid solution and/or an aqueous metal cation solution to obtain a treated poly(phenylene sulfide) polymer; (iv) drying at least a portion of the raw poly(phenylene sulfide) polymer and/or treated poly(phenylene sulfide) polymer to obtain a dried poly(phenylene sulfide) polymer; (v) evaporating a portion of the first slurry to obtain a by-product slurry, wherein the by-product slurry comprises slurry particulates; and (vi) evaporating at least a portion of the N-methyl-2-pyrrolidone and/or water from the by-product slurry to yield salt solids particulates, wherein at least a portion of the evaporating is carried out while simultaneously sizing the salt solids particulates to a desired size, and wherein the salt solids particulates comprise equal to or less than about 5 wt. % N-methyl-2-pyrrolidone.

In an embodiment, a process for recovering N-methyl-2-pyrrolidone during production of poly(phenylene sulfide) polymer can comprise (i) reacting a sulfur source and a dihaloaromatic compound in the presence of N-methyl-2-pyrrolidone to form a poly(phenylene sulfide) reaction mixture; (ii) washing the poly(phenylene sulfide) reaction mixture with N-methyl-2-pyrrolidone and/or water to obtain a raw poly(phenylene sulfide) polymer and a first slurry; (iii) treating at least a portion of the raw poly(phenylene sulfide) polymer with an aqueous acid solution and/or an aqueous metal cation solution to obtain a treated poly(phenylene sulfide) polymer; (iv) drying at least a portion of the raw poly(phenylene sulfide) polymer and/or treated poly(phenylene sulfide) polymer to obtain a dried poly(phenylene sulfide) polymer; (v) evaporating a portion of the first slurry to obtain a by-product slurry and a vapor stream, wherein the by-product slurry comprises slurry particulates; and (vi) evaporating at least a portion of the N-methyl-2-pyrrolidone and/or water from the by-product slurry to yield salt solids particulates and recovered N-methyl-2-pyrrolidone, wherein at least a portion of the evaporating is carried out while simultaneously sizing the salt solids particulates to a desired size, wherein the salt solids particulates comprise equal to or less than about 5 wt. % N-methyl-2-pyrrolidone, and wherein at least a portion of the recovered N-methyl-2-pyrrolidone can be re-used in step (i), step (ii), or both.

In an embodiment, a system for producing a poly(phenylene sulfide) polymer can comprise (a) a reactor, wherein a sulfur source and a dihaloaromatic compound are reacted in the presence of N-methyl-2-pyrrolidone to form a poly(phenylene sulfide) reaction mixture; (b) a washing vessel receiving the poly(phenylene sulfide) reaction mixture, wherein the poly(phenylene sulfide) reaction mixture is washed with N-methyl-2-pyrrolidone and/or water to obtain a washed poly(phenylene sulfide) polymer and by-product slurry; and (c) a sizing dryer receiving the by-product slurry, wherein at least a portion of the by-product slurry is evaporated to yield salt solids particulates, wherein at least a portion of the evaporating is carried out while simultaneously sizing the salt solids particulates to a desired size, and wherein the salt solids particulates comprise equal to or less than about 5 wt. % N-methyl-2-pyrrolidone.

In an embodiment, the process for the production of a poly(arylene sulfide) polymer as disclosed herein advantageously displays improvements in one or more process characteristics when compared to an otherwise similar process lacking a step of evaporating at least a portion of the by-product slurry to yield salt solids particulates, wherein at least a portion of the evaporating is carried out while simultaneously sizing the salt solids particulates to a desired size. For example, conventional dryers (e.g., dryers that would be employed for a step of evaporating at least a portion of the polar organic compound from the by-product slurry) sometimes allow the formation of large rock-solid clumps (e.g., agglomerations of salt solids particles, agglomerations of slurry particles, etc.) that could cause the equipment to be shut down, and thus could cause the entire process for the production of a polymer (e.g., a poly(arylene sulfide) polymer) to be shut down, thereby causing monetary damages due to down time. The use of the sizing dryer as disclosed herein can advantageously reduce and/or eliminate down time by not allowing the formation of large rock-solid clumps (e.g., agglomerations of salt solids particles, agglomerations of slurry particles, etc.) in the sizing dryer and/or by removing any such large rock-solid clumps (e.g., agglomerations of salt solids particles, agglomerations of slurry particles, etc.) that might have formed by using a high shear tool.

In an embodiment, the use of the sizing dryer as disclosed herein can advantageously maintain flowability of materials (e.g., by-product slurry, slurry particulates, salt solids particulates, etc.) through the dryer. In such embodiment, the use of the sizing dryer as disclosed herein can advantageously display improved operation of equipment, improved reliability of equipment, reduced operational problems (e.g., equipment plugging), reduced down time resulting in a more continuous process operation, etc. Additional advantages of the process for the production of a poly(arylene sulfide) polymer as disclosed herein can be apparent to one of skill in the art viewing this disclosure.

For the purpose of any U.S. national stage filing from this application, all publications and patents mentioned in this disclosure are incorporated herein by reference in their entireties, for the purpose of describing and disclosing the constructs and methodologies described in those publications, which might be used in connection with the methods of this disclosure. Any publications and patents discussed herein are provided solely for their disclosure prior to the filing date of the present application. Nothing herein is to be construed as an admission that the inventors are not entitled to antedate such disclosure by virtue of prior invention.

In any application before the United States Patent and Trademark Office, the Abstract of this application is provided for the purpose of satisfying the requirements of 37 C.F.R. §1.72 and the purpose stated in 37 C.F.R. §1.72(b) “to enable the United States Patent and Trademark Office and the public generally to determine quickly from a cursory inspection the nature and gist of the technical disclosure.” Therefore, the Abstract of this application is not intended to be used to construe the scope of the claims or to limit the scope of the subject matter that is disclosed herein. Moreover, any headings that can be employed herein are also not intended to be used to construe the scope of the claims or to limit the scope of the subject matter that is disclosed herein. Any use of the past tense to describe an example otherwise indicated as constructive or prophetic is not intended to reflect that the constructive or prophetic example has actually been carried out.

The present disclosure is further illustrated by the following examples, which are not to be construed in any way as imposing limitations upon the scope thereof. On the contrary, it is to be clearly understood that resort can be had to various other aspects, embodiments, modifications, and equivalents thereof which, after reading the description herein, can be suggest to one of ordinary skill in the art without departing from the spirit of the present invention or the scope of the appended claims.

### ADDITIONAL DISCLOSURE

A first embodiment, which is a process for producing a poly(arylene sulfide) polymer comprising:

(a) polymerizing reactants in a reaction vessel to produce a poly(arylene sulfide) reaction mixture;

(b) processing the poly(arylene sulfide) reaction mixture to obtain a poly(arylene sulfide) polymer and a by-product slurry;

(c) removing (e.g., evaporating) at least a portion of the by-product slurry to yield salt solids particulates, wherein at least a portion of the evaporating is carried out while simultaneously sizing the salt solids particulates to a desired size.

A second embodiment, which is the process of the first embodiment, wherein evaporating at least a portion of the by-product slurry to yield salt solids particulates comprises introducing the by-product slurry to a sizing dryer, wherein at least a portion of liquid in the by-product slurry is evaporated and the desired size of the salt solids particulates is provided by the sizing dryer.

A third embodiment, which is the process of the second embodiment, wherein sizing the salt solids particulates comprises mechanically reducing a size of the particulates and/or preventing agglomeration of the particulates.

A fourth embodiment, which is the process of the third embodiment, wherein mechanically reducing a size of particulates and/or preventing agglomeration of particulates comprises chopping, grinding, or combinations thereof.

A fifth embodiment, which is the process of any of the second through the fourth embodiments, wherein the sizing dryer comprises a mechanically fluidized bed mixing device.

A sixth embodiment, which is the process of any of the second through the fourth embodiments, wherein the sizing dryer comprises a plurality of mixing tools, wherein the mixing tools create one or more low shear zones, thereby mechanically reducing a size of particulates and/or preventing agglomeration of particulates.

A seventh embodiment, which is the process of the sixth embodiment, wherein the mixing tools comprise shear tools, blades, sharpened blades, plow or plough blades, sharpened plow blades, paddles, sharpened paddles, choppers, augers, screws, or combinations thereof.

An eighth embodiment, which is the process of any of the second through the seventh embodiments, wherein the sizing dryer is used upstream of a conventional dryer, wherein the conventional dryer is used for further drying the salt solids particulates.

A ninth embodiment, which is the process of any of the second through the eighth embodiments, wherein the sizing dryer is used in place of a conventional dryer.

A tenth embodiment, which is the process of any of the second through the ninth embodiments, wherein the sizing dryer further comprises one or more high shear tools, wherein the high shear tools create one or more high shear zones, thereby mechanically reducing size of particulates and/or preventing agglomeration of particulates.

An eleventh embodiment, which is the process of the tenth embodiment, wherein the high shear tool comprises a chopper device, a high shear chopper device, a high velocity chopper device, an impeller, a high shear impeller, a high velocity impeller, a propeller, a high shear propeller, a high velocity propeller, a propeller with sharpened blades, or combinations thereof.

A twelfth embodiment, which is the process of any of the second through the eleventh embodiments, wherein the sizing dryer is heated by external heating, jacket heating, internal heating, introducing steam to the sizing dryer, heating internal elements of the sizing dryer, wherein the internal elements can comprise a shaft and/or a mixing tool, or combinations thereof.

A thirteenth embodiment, which is the process of any of the second through the twelfth embodiments, wherein the sizing dryer comprises a plow mixer.

A fourteenth embodiment, which is the process of any of the second through the thirteenth embodiments, wherein the sizing dryer comprises a chopping dryer.

A fifteenth embodiment, which is the process of the fourteenth embodiment, wherein the chopping dryer comprises a receiving end, a delivering end, and an elongated mixing chamber, wherein the elongated mixing chamber is disposed between the receiving end and the delivering end.

A sixteenth embodiment, which is the process of the fifteenth embodiment, wherein the elongated mixing chamber is disposed horizontally with respect to a ground surface on which it rests.

A seventeenth embodiment, which is the process of any of the fifteenth through the sixteenth embodiments, wherein the elongated mixing chamber is sloped with respect to a ground surface on which it rests.

An eighteenth embodiment, which is the process of any of the fourteenth through the seventeenth embodiments, wherein the chopping dryer comprises a mixing shaft and a plurality of mixing tools, wherein the mixing tools are attached to the mixing shaft, and wherein the mixing shaft rotates within the chopping dryer, thereby causing the mixing tools to rotate and create one or more low shear zones, thereby mechanically reducing size of particulates and/or preventing agglomeration of particulates.

A nineteenth embodiment, which is the process of the eighteenth embodiment, wherein the chopping dryer further comprises one or more high shear ports and one or more high shear tools, wherein a high shear tool is inserted into the chopping dryer through a high shear port, wherein a longitudinal high shear axis of the high shear tool is perpendicular on a longitudinal shaft axis of the mixing shaft, wherein the high shear tool is spatially located between two adjacent mixing tools, wherein the high shear tool does not touch either the mixing tools or the mixing shaft, and wherein the high shear tools create one or more high shear zones, thereby mechanically reducing size of particulates and/or preventing agglomeration of particulates.

A twentieth embodiment, which is the process of any of the fifteenth through the nineteenth embodiments, wherein the receiving end comprises a by-product slurry port.

A twenty-first embodiment, which is the process of any of the fifteenth through the twentieth embodiments, wherein the receiving end further comprises a steam port, wherein the by-product slurry port is a circular port, wherein the steam port is an annular circular port, wherein the by-product slurry port and the steam port are concentric, and wherein the steam port surrounds the by-product slurry port.

A twenty-second embodiment, which is the process of any of the fifteenth through the twenty-first embodiments, wherein the delivering end comprises a salt solids particulates outlet, wherein the salt solids particulate outlet has a circular cross section, and wherein a ratio of a size of the salt solids particulates to the diameter of the circular cross section of the salt solids particulates outlet is less than about 0.9.

A twenty-third embodiment, which is the process of any of the first through the twenty-second embodiments, wherein the by-product slurry comprises slurry particulates, and wherein a ratio of a size of the salt solids particulates to a size of the slurry particulates is less than about 10.

A twenty-fourth embodiment, which is the process of any of the first through the twenty-third embodiments, wherein the salt solids particulates comprise an alkali metal halide by-product in an amount of from about 50 wt. % to about 99 wt. %, based on the total weight of the salt solids particulates.

A twenty-fifth embodiment, which is the process of any of the first through the twenty-fourth embodiments, wherein the salt solids particulates comprise polymer impurities in an amount of from about 1 wt. % to about 30 wt. %, based on the total weight of the salt solids particulates.

A twenty-sixth embodiment, which is the process of the twenty-fourth embodiment, wherein the alkali metal halide by-product comprises NaCl.

A twenty-seventh embodiment, which is the process of any of the first through the twenty-sixth embodiments, wherein polymerizing reactants further comprises reacting a sulfur source and a dihaloaromatic compound in the presence of a polar organic compound to form the poly(arylene sulfide) polymer.

A twenty-eighth embodiment, which is the process of any of the first through the twenty-seventh embodiments, wherein the poly(arylene sulfide) is a poly(phenylene sulfide).

A twenty-ninth embodiment, which is the process of any of the first through the twenty-eighth embodiments, wherein processing the poly(arylene sulfide) reaction mixture comprises washing the poly(arylene sulfide) reaction mixture with a polar organic compound and/or water to obtain a raw poly(arylene sulfide) polymer and a first slurry.

A thirtieth embodiment, which is the process of the twenty-ninth embodiment, wherein at least a portion of the raw poly(arylene sulfide) polymer is treated with an aqueous acid solution and/or an aqueous metal cation solution to obtain a treated poly(arylene sulfide) polymer.

A thirty-first embodiment, which is the process of the thirtieth embodiment, wherein at least a portion of the raw poly(arylene sulfide) polymer and/or treated poly(arylene sulfide) polymer is dried to obtain a dried poly(arylene sulfide) polymer.

A thirty-second embodiment, which is the process of any of the twenty-ninth through the thirty-first embodiments, wherein at least a portion of the first slurry is evaporated to obtain the by-product slurry.

A thirty-third embodiment, which is a process for producing a poly(phenylene sulfide) polymer comprising:

(a) polymerizing reactants in a reaction vessel to produce a poly(phenylene sulfide) reaction mixture;

(b) processing the poly(phenylene sulfide) reaction mixture to obtain a poly(phenylene sulfide) polymer and a by-product slurry; and
(c) removing (e.g., evaporating) at least a portion of the by-product slurry to yield salt solids particulates, wherein at least a portion of the evaporating is carried out while simultaneously sizing the salt solids particulates to a desired size.

A thirty-fourth embodiment, which is a process for producing a poly(phenylene sulfide) polymer comprising:

(a) reacting a sulfur source and a dihaloaromatic compound in the presence of N-methyl-2-pyrrolidone to form a poly(phenylene sulfide) reaction mixture;

(b) washing the poly(phenylene sulfide) reaction mixture with N-methyl-2-pyrrolidone and/or water to obtain a washed poly(phenylene sulfide) polymer and by-product slurry; and

(c) removing (e.g., evaporating) at least a portion of the by-product slurry to yield salt solids particulates, wherein at least a portion of the evaporating is carried out while simultaneously sizing the salt solids particulates to a desired size.

A thirty-fifth embodiment, which is the process of the thirty-fourth embodiment, wherein the salt solids particulates comprise equal to or less than about 5 weight percent N-methyl-2-pyrrolidone.

A thirty-sixth embodiment, which is a process for producing a poly(arylene sulfide) polymer comprising:

(i) polymerizing reactants in a reaction vessel to produce a poly(arylene sulfide) reaction mixture;

(ii) washing the poly(arylene sulfide) reaction mixture with a polar organic compound and/or water to obtain a raw poly(arylene sulfide) polymer and a first slurry;

(iii) treating at least a portion of the raw poly(arylene sulfide) polymer with an aqueous acid solution and/or an aqueous metal cation solution to obtain a treated poly(arylene sulfide) polymer;

(iv) drying at least a portion of the raw poly(arylene sulfide) polymer and/or treated poly(arylene sulfide) polymer to obtain a dried poly(arylene sulfide) polymer;

(v) removing (e.g., evaporating) a portion of the first slurry to obtain a by-product slurry, wherein the by-product slurry comprises slurry particulates; and

(vi) removing (e.g., evaporating) at least a portion of the polar organic compound and/or water from the by-product slurry to yield salt solids particulates, wherein at least a portion of the evaporating is carried out while simultaneously sizing the salt solids particulates to a desired size.

A thirty-seventh embodiment, which is a process for producing a poly(phenylene sulfide) polymer comprising:

(i) reacting a sulfur source and a dihaloaromatic compound in the presence of N-methyl-2-pyrrolidone to form a poly(phenylene sulfide) reaction mixture;

(ii) washing the poly(phenylene sulfide) reaction mixture with N-methyl-2-pyrrolidone and/or water to obtain a raw poly(phenylene sulfide) polymer and a first slurry;

(iii) treating at least a portion of the raw poly(phenylene sulfide) polymer with an aqueous acid solution and/or an aqueous metal cation solution to obtain a treated poly(phenylene sulfide) polymer;

(iv) drying at least a portion of the raw poly(phenylene sulfide) polymer and/or treated poly(phenylene sulfide) polymer to obtain a dried poly(phenylene sulfide) polymer;

(v) removing (e.g., evaporating) a portion of the first slurry to obtain a by-product slurry, wherein the by-product slurry comprises slurry particulates; and
(vi) removing (e.g., evaporating) at least a portion of the N-methyl-2-pyrrolidone and/or water from the by-product slurry to yield salt solids particulates, wherein at least a portion of the evaporating is carried out while simultaneously sizing the salt solids particulates to a desired size.

A thirty-eighth embodiment, which is the process of the thirty-seventh embodiment, wherein the salt solids particulates comprise equal to or less than about 5 weight percent N-methyl-2-pyrrolidone.

A thirty-ninth embodiment, which is a process for recovering N-methyl-2-pyrrolidone during production of poly(phenylene sulfide) polymer, comprising:

(i) reacting a sulfur source and a dihaloaromatic compound in the presence of N-methyl-2-pyrrolidone to form a poly(phenylene sulfide) reaction mixture;

(ii) washing the poly(phenylene sulfide) reaction mixture with N-methyl-2-pyrrolidone and/or water to obtain a raw poly(phenylene sulfide) polymer and a first slurry;

(iii) treating at least a portion of the raw poly(phenylene sulfide) polymer with an aqueous acid solution and/or an aqueous metal cation solution to obtain a treated poly(phenylene sulfide) polymer;

(iv) drying at least a portion of the raw poly(phenylene sulfide) polymer and/or treated poly(phenylene sulfide) polymer to obtain a dried poly(phenylene sulfide) polymer;

(v) removing (e.g., evaporating) a portion of the first slurry to obtain a by-product slurry and a vapor stream, wherein the by-product slurry comprises slurry particulates; and

(vi) removing (e.g., evaporating) at least a portion of the N-methyl-2-pyrrolidone and/or water from the by-product slurry to yield salt solids particulates and recovered N-methyl-2-pyrrolidone, wherein at least a portion of the evaporating is carried out while simultaneously sizing the salt solids particulates to a desired size, wherein the salt solids particulates comprise equal to or less than 5 weight percent N-methyl-2-pyrrolidone, and wherein at least a portion of the recovered N-methyl-2-pyrrolidone is re-used in step (i), step (ii), or both.

A fortieth embodiment, which is a system for producing a poly(phenylene sulfide) polymer comprising:

(a) a reactor, wherein a sulfur source and a dihaloaromatic compound are reacted in the presence of N-methyl-2-pyrrolidone to form a poly(phenylene sulfide) reaction mixture;

(b) a washing vessel receiving the poly(phenylene sulfide) reaction mixture, wherein the poly(phenylene sulfide) reaction mixture is washed with N-methyl-2-pyrrolidone and/or water to obtain a washed poly(phenylene sulfide) polymer and by-product slurry; and

(c) a sizing dryer receiving the by-product slurry, wherein at least a portion of the by-product slurry is removed (e.g., evaporated) to yield salt solids particulates, wherein at least a portion of the removing (e.g., evaporating) is carried out while simultaneously sizing the salt solids particulates to a desired size, and wherein the salt solids particulates comprise equal to or less than about 5 weight percent N-methyl-2-pyrrolidone.

While embodiments of the disclosure have been shown and described, modifications thereof can be made without departing from the spirit and teachings of the invention. The embodiments and examples described herein are exemplary only, and are not intended to be limiting. Many variations and modifications of the invention disclosed herein are possible and are within the scope of the invention.

Accordingly, the scope of protection is not limited by the description set out above but is only limited by the claims which follow, that scope including all equivalents of the subject matter of the claims. Each and every claim is incorporated into the specification as an embodiment of the present invention. Thus, the claims are a further description and are an addition to the detailed description of the present invention. The disclosures of all patents, patent applications, and publications cited herein are hereby incorporated by reference.

What is claimed is:

1. A process for producing a poly(arylene sulfide) polymer comprising:
(a) polymerizing reactants in a reaction vessel to produce a poly(arylene sulfide) reaction mixture;
(b) processing the poly(arylene sulfide) reaction mixture to obtain a poly(arylene sulfide) polymer and a by-product slurry;
(c) evaporating at least a portion of the by-product slurry to yield salt solids particulates, wherein at least a portion of the evaporating is carried out while simultaneously sizing the salt solids particulates to a desired size.

2. The process of claim 1, wherein evaporating at least a portion of the by-product slurry to yield salt solids particulates comprises introducing the by-product slurry to a sizing dryer, wherein at least a portion of liquid in the by-product slurry is evaporated and the desired size of the salt solids particulates is provided by the sizing dryer.

3. The process of claim 2, wherein sizing the salt solids particulates comprises mechanically reducing a size of the particulates and/or preventing agglomeration of the particulates.

4. The process of claim 3, wherein mechanically reducing a size of particulates and/or preventing agglomeration of particulates comprises chopping, grinding, or combinations thereof.

5. The process of claim 2, wherein the sizing dryer comprises a mechanically fluidized bed mixing device.

6. The process of claim 2, wherein the sizing dryer comprises a plurality of mixing tools, wherein the mixing tools create one or more low shear zones, thereby mechanically reducing a size of particulates and/or preventing agglomeration of particulates.

7. The process of claim 6, wherein the mixing tools comprise shear tools, blades, sharpened blades, plow or plough blades, sharpened plow blades, paddles, sharpened paddles, choppers, augers, screws, or combinations thereof.

8. The process of claim 2, wherein the sizing dryer further comprises one or more high shear tools, wherein the high shear tools create one or more high shear zones, thereby mechanically reducing size of particulates and/or preventing agglomeration of particulates.

9. The process of claim 8, wherein the high shear tool comprises a chopper device, a high shear chopper device, a high velocity chopper device, an impeller, a high shear impeller, a high velocity impeller, a propeller, a high shear propeller, a high velocity propeller, a propeller with sharpened blades, or combinations thereof.

10. The process of claim 2, wherein the sizing dryer is heated by external heating, jacket heating, internal heating, introducing steam to the sizing dryer, heating internal elements of the sizing dryer, wherein the internal elements can comprise a shaft and/or a mixing tool, or combinations thereof.

11. The process of claim 2, wherein the sizing dryer comprises a plow mixer.

12. The process of claim 2, wherein the sizing dryer comprises a chopping dryer.

13. The process of claim 12, wherein the chopping dryer comprises a receiving end, a delivering end, and an elongated mixing chamber, wherein the elongated mixing chamber is disposed between the receiving end and the delivering end.

14. The process of claim 12, wherein the chopping dryer comprises a mixing shaft and a plurality of mixing tools, wherein the mixing tools are attached to the mixing shaft, and wherein the mixing shaft rotates within the chopping dryer, thereby causing the mixing tools to rotate and create one or more low shear zones, thereby mechanically reducing size of particulates and/or preventing agglomeration of particulates.

15. The process of claim 14, wherein the chopping dryer further comprises one or more high shear ports and one or more high shear tools, wherein a high shear tool is inserted into the chopping dryer through a high shear port, wherein a longitudinal high shear axis of the high shear tool is perpendicular on a longitudinal shaft axis of the mixing shaft, wherein the high shear tool is spatially located between two adjacent mixing tools, wherein the high shear tool does not touch either the mixing tools or the mixing shaft, and wherein the high shear tools create one or more high shear zones, thereby mechanically reducing size of particulates and/or preventing agglomeration of particulates.

16. A process for producing a poly(phenylene sulfide) polymer comprising:
(i) reacting a sulfur source and a dihaloaromatic compound in the presence of N-methyl-2-pyrrolidone to form a poly(phenylene sulfide) reaction mixture;
(ii) washing the poly(phenylene sulfide) reaction mixture with N-methyl-2-pyrrolidone and/or water to obtain a raw poly(phenylene sulfide) polymer and a first slurry;
(iii) treating at least a portion of the raw poly(phenylene sulfide) polymer with an aqueous acid solution and/or an aqueous metal cation solution to obtain a treated poly(phenylene sulfide) polymer;
(iv) drying at least a portion of the raw poly(phenylene sulfide) polymer and/or treated poly(phenylene sulfide) polymer to obtain a dried poly(phenylene sulfide) polymer;
(v) evaporating a portion of the first slurry to obtain a by-product slurry, wherein the by-product slurry comprises slurry particulates; and
(vi) evaporating at least a portion of the N-methyl-2-pyrrolidone and/or water from the by-product slurry to yield salt solids particulates, wherein at least a portion of the evaporating is carried out while simultaneously sizing the salt solids particulates to a desired size.

17. The process of claim 1, wherein the salt solids particulates comprise equal to or less than about 5 weight percent polar organic compound.

18. The process of claim 16, wherein the salt solids particulates comprise equal to or less than about 5 weight percent N-methyl-2-pyrrolidone.

19. A process for recovering N-methyl-2-pyrrolidone during production of poly(phenylene sulfide) polymer, comprising:
(i) reacting a sulfur source and a dihaloaromatic compound in the presence of N-methyl-2-pyrrolidone to form a poly(phenylene sulfide) reaction mixture;
(ii) washing the poly(phenylene sulfide) reaction mixture with N-methyl-2-pyrrolidone and/or water to obtain a raw poly(phenylene sulfide) polymer and a first slurry;
(iii) treating at least a portion of the raw poly(phenylene sulfide) polymer with an aqueous acid solution and/or an aqueous metal cation solution to obtain a treated poly(phenylene sulfide) polymer;
(iv) drying at least a portion of the raw poly(phenylene sulfide) polymer and/or treated poly(phenylene sulfide) polymer to obtain a dried poly(phenylene sulfide) polymer;
(v) evaporating a portion of the first slurry to obtain a by-product slurry and a vapor stream, wherein the by-product slurry comprises slurry particulates; and
(vi) evaporating at least a portion of the N-methyl-2-pyrrolidone and/or water from the by-product slurry to yield salt solids particulates and recovered N-methyl-2-pyrrolidone, wherein at least a portion of the evaporating is carried out while simultaneously sizing the salt solids particulates to a desired size, and wherein at least a portion of the recovered N-methyl-2-pyrrolidone is re-used in step (i), step (ii), or both.

20. The process of claim 19, wherein the salt solids particulates comprise equal to or less than about 5 weight percent N-methyl-2-pyrrolidone.
